(19) United States
(12) Patent Application Publication
(10) Pub. No.: US 2025/0240666 A1
(43) Pub. Date: Jul. 24, 2025

(54) ELECTRONIC DEVICE FOR SETTING INTERFACE OPERATION MODE ON BASIS OF MAXIMUM DATA RATE OF PLURALITY OF LINKS, AND OPERATION METHOD FOR SAME

(71) Applicant: Samsung Electronics Co., Ltd., Suwon-si (KR)

(72) Inventors: Mincheol JEONG, Suwon-si (KR); Hyunkee MIN, Suwon-si (KR); Sungbin MIN, Suwon-si (KR); Eonji LEE, Suwon-si (KR); Taeyong KIM, Suwon-si (KR); Sunkee LEE, Suwon-si (KR)

(21) Appl. No.: 19/175,550

(22) Filed: Apr. 10, 2025

Related U.S. Application Data
(63) Continuation of application No. PCT/KR2023/015540, filed on Oct. 10, 2023.

(30) Foreign Application Priority Data
Oct. 28, 2022 (KR) 10-2022-0141737
Dec. 8, 2022 (KR) 10-2022-0170947

(51) Int. Cl. H04W 28/02; H04L 1/00; H04W 8/22; H04W 76/10

(52) U.S. Cl. CPC H04W 28/0257; H04L 1/0003; H04W 8/22; H04W 76/10

(57) ABSTRACT

An electronic device and an operation method of the same are provided. The electronic device includes memory storing one or more computer programs, a communication module that includes a communication circuit that supports short-range wireless communication through a plurality of links, one or more processors communicatively coupled to the memory and the communication module, and an application processor electrically connected to the communication module through an interface supporting a plurality of operation modes, wherein the one or more computer programs include computer-executable instructions that, when executed by the one or more processors individually or collectively, cause the electronic device to confirm the maximum data rate of each of the plurality of links on the basis of capability information, received from an external electronic device, about the external electronic device, confirm the maximum data rate of the plurality of links on the basis of an operation mode of the short-range wireless communication, select one of a plurality of operation modes of the interface on the basis of the maximum data rate of the plurality of links, and transmit data to the application processor through the selected operation mode, or receive data, transmitted by the application processor, through the selected interface.

### CROSS-REFERENCE TO RELATED APPLICATION(S)

This application is a continuation application, claiming priority under 35 U.S.C. § 365(c), of an International application No. PCT/KR2023/015540, filed on Oct. 10, 2023, which is based on and claims the benefit of a Korean patent application number 10-2022-0141737, filed on Oct. 28, 2022, in the Korean Intellectual Property Office, and of a Korean patent application number 10-2022-0170947, filed on Dec. 8, 2022, in the Korean Intellectual Property Office, the disclosure of each of which is incorporated by reference herein in its entirety.

### BACKGROUND

### 1. Field

The disclosure relates to an electronic device and a method of operating the electronic device and a technology for configuring an operating mode of an interface between an application processor and a communication module, based on the maximum data rate of multiple links.

### 2. Description of Related Art

With the proliferation of various electronic devices, improvements have been made in the speed of wireless communication that can be used by various electronic devices. Among the wireless communications supported by recent electronic devices, IEEE 802.11 wireless local area network (WLAN) (or wireless fidelity (Wi-Fi)) is a standard for implementing high-speed wireless connections on various electronic devices. The first implemented Wi-Fi could support transmission speeds of a maximum of 1 to 9 Mbps, but Wi-Fi 6 technology (or IEEE 802.11 ax) may support transmission speeds of a maximum of about 10 Gbps.

Electronic devices may support various services (e.g., ultra-high definition (UHD)-quality video streaming service, augmented reality (AR) service, virtual reality (VR) service, or mixed reality (MR) service) using relatively large capacity data through wireless communication supporting high transmission rates, and various other services may be supported.

The above information is presented as background information only to assist with an understanding of the disclosure. No determination has been made, and no assertion is made, as to whether any of the above might be applicable as prior art with regard to the disclosure.

### SUMMARY

The electronic device may generate a channel for data exchange with an external electronic device (or an access point (AP)) and transmit or receive data through the generated channel.

The electronic device may provide an interface between an application processor and a communication module, the interface being used to transmit and/or receive data. The interface may support multiple operating modes with different maximum data rates. However, a situation may occur where the maximum data rate of the channel generated between the electronic device and the external electronic device and the maximum data rate supported by the operating mode of the interface are significantly different. In this case, a decrease in the data transmission rate (or reception rate) and/or an increase in power consumption may occur.

Aspects of the disclosure are to address at least the above-mentioned problems and/or disadvantages and to provide at least the advantages described below. Accordingly, an aspect of the disclosure is to provide an electronic device and a method of operating the electronic device and a technology for configuring an operating mode of an interface between an application processor and a communication module, based on the maximum data rate of multiple links.

Additional aspects will be set forth in part in the description which follows and, in part, will be apparent from the description, or may be learned by practice of the presented embodiments.

In accordance with an aspect of the disclosure, an electronic device is provided. The electronic device include memory storing one or more computer programs, a communication module including a communication circuit supporting short-range wireless communication through multiple links, one or more processors communicatively coupled to the memory and the communication module, and an application processor electrically connected to the communication module through an interface supporting multiple operating modes, wherein the one or more computer programs include computer-executable instructions that, when executed by the one or more processors individually or collectively, cause the electronic device to: identify the maximum data rate of each of the multiple links, based on capability information of an external electronic device, received from the external electronic device, identify the maximum data rate of the multiple links, based on an operating mode for the short-range wireless communication, select one of the multiple operating modes of the interface, based on the maximum data rate of the multiple links, and transmit data to the application processor through the selected operating mode, or receive data, transmitted by the application processor, through the selected interface.

In accordance with another aspect of the disclosure, a method of operating an electronic device is provided. The method includes identifying the maximum data rate of each of multiple links for short-range wireless communication, based on capability information of an external electronic device, received from the external electronic device, determining the maximum data rate of the multiple links, based on an operating mode for the short-range wireless communication, based on the maximum data rate of the multiple links, selecting one of multiple operating modes supported by an interface between an application processor and a communication module, and transmitting data to the application processor through the selected operating mode, or receiving data, transmitted by the application processor, through the selected interface.

In accordance with another aspect of the disclosure, one or more non-transitory computer-readable storage media storing one or more computer programs including computer-executable instructions that, when executed by one or more processors of an electronic device individually or collectively, cause the electronic device to perform operations is provided. The operations include identifying the maximum data rate of each of multiple links for short-range wireless communication, based on capability information of an external electronic device, received from the external electronic device, determining the maximum data rate of the multiple links, based on an operating mode for the short-range wireless communication, based on the maximum data rate of the multiple links, selecting one of multiple operating modes supported by an interface between an application processor and a communication module, and transmitting data to the application processor through the selected operating mode, or receiving data, transmitted by the application processor, through the selected interface.

According to an electronic device and a method for operating an electronic device according to various embodiments of the disclosure, the maximum data rate of multiple links is determined based on an operating mode for short-range wireless communication and capability information of an external electronic device, received in the process of establishing multiple links between the external electronic device and the electronic device. The electronic device selects (or determines) an operating mode of an interface, based on the maximum data rate of multiple links, and transmits data through an interface in which the selected operating mode is active. The selected operating mode is an operating mode supporting a higher data rate than the maximum data rate of the multiple links. Accordingly, the electronic device prevents a bottleneck phenomenon that occurs by operating in an operating mode supporting a data rate lower than the maximum data rate of the multiple links.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment of the disclosure;

FIG. 2 is a block diagram of a program according to an embodiment of the disclosure;

FIG. 3A illustrates an embodiment in which an electronic device and an access point (AP) operate in multi-link operation (MLO) according to an embodiment of the disclosure;

FIG. 3B illustrates an embodiment in which an electronic device operates in a non-simultaneous transmission and reception (STR) mode according to an embodiment of the disclosure;

FIG. 3C illustrates an embodiment in which an electronic device operates in an enhanced multi-link with single radio (EMLSR) mode according to an embodiment of the disclosure;

FIG. 4 illustrates an embodiment in which an electronic device is connected to an external electronic device through short-range wireless communication according to an embodiment of the disclosure;

FIG. 5 is a block diagram of an electronic device according to an embodiment of the disclosure;

FIG. 6 illustrates an embodiment in which an electronic device connects an interface between an application processor and a communication module according to an embodiment of the disclosure;

FIG. 7 is an operation flowchart illustrating a method of operating an electronic device according to an embodiment of the disclosure;

FIG. 8 is an operation flowchart illustrating a method of operating an electronic device according to an embodiment of the disclosure;

FIG. 9 is an operation flowchart illustrating a method of operating an electronic device according to an embodiment of the disclosure; and

FIG. 10 is an operation flowchart illustrating a method of operating an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

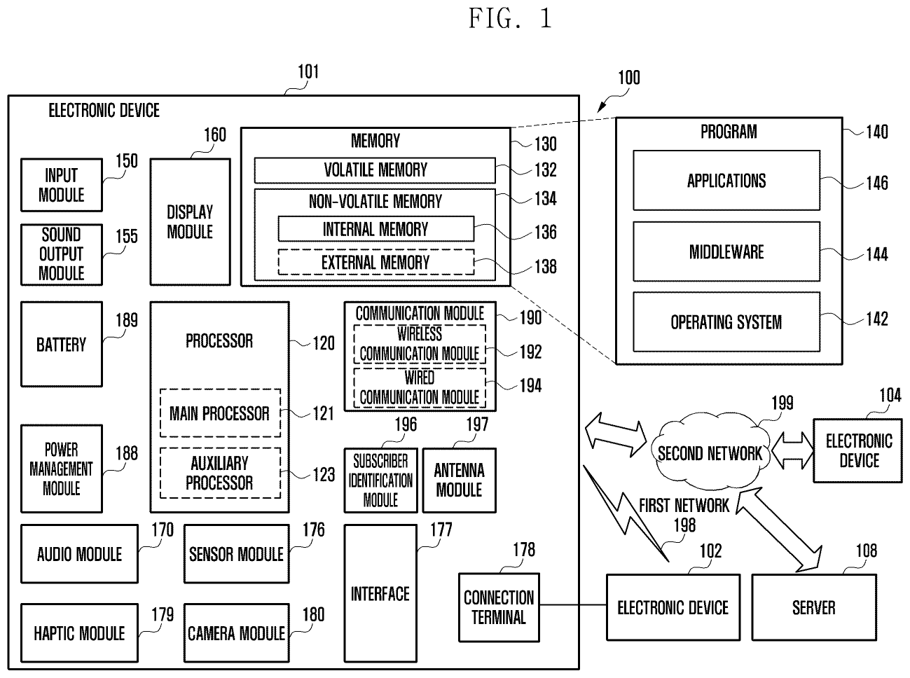

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). In an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to another embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to another embodiment, the auxiliary processor 123 (e.g., an image signal processor or a communication processor) may be implemented as part of another component (e.g., the camera module 180 or the communication module 190) functionally related to the auxiliary processor 123. In an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. In an embodiment, the input module 150 may include, for example, a microphone, a mouse, a keyboard, a key (e.g., a button), or a digital pen (e.g., a stylus pen).

The sound output module 155 may output sound signals to the outside of the electronic device 101. In an embodiment, the sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. In an embodiment, the display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to another embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to another embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to another embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). The connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to another embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. In one embodiment, the power management module 188 may be implemented as at least part of, for example, a power management integrated circuit (PMIC).

The battery 189 may supply power to at least one component of the electronic device 101. In an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to another embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may, for example, support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to some embodiments, the antenna module 197 may form a mmWave antenna module. According to another embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to another embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

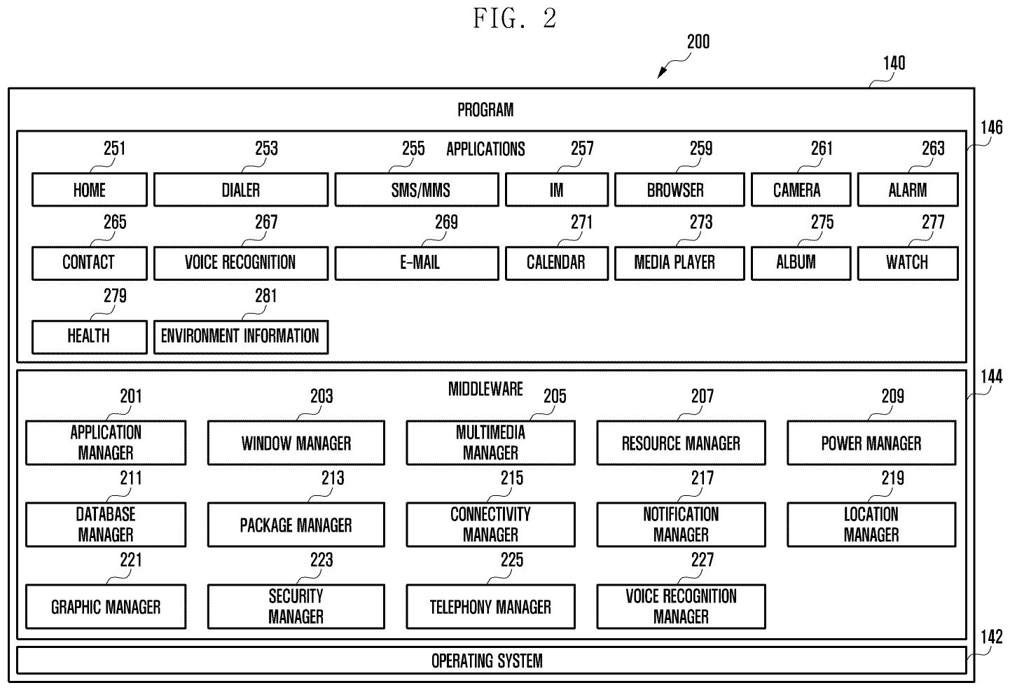

FIG. 2 is a block diagram 200 illustrating the program 140 according to an embodiment of the disclosure.

The program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. In an embodiment, the middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to another embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. In an embodiment, the connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. In an embodiment, the voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to another embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display module or a camera module of the external electronic device). In an embodiment, the device management application, additionally or alternatively, may support installation, delete, or update of an application running on the external electronic device.

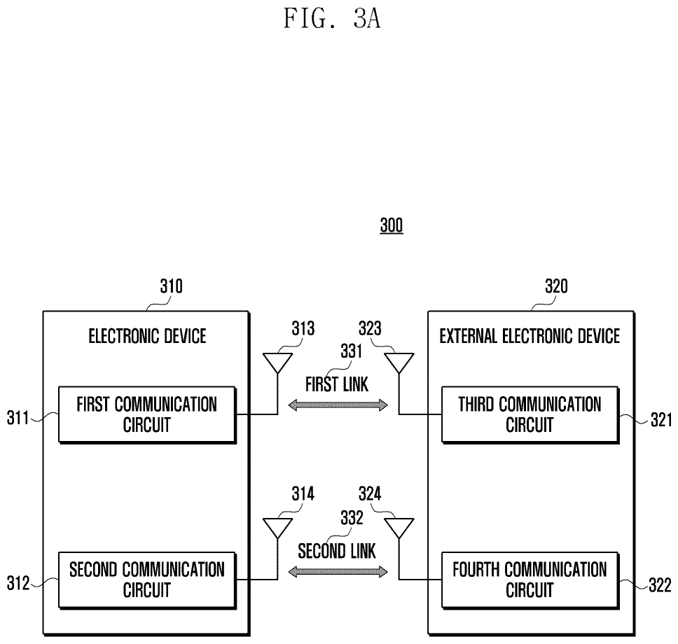

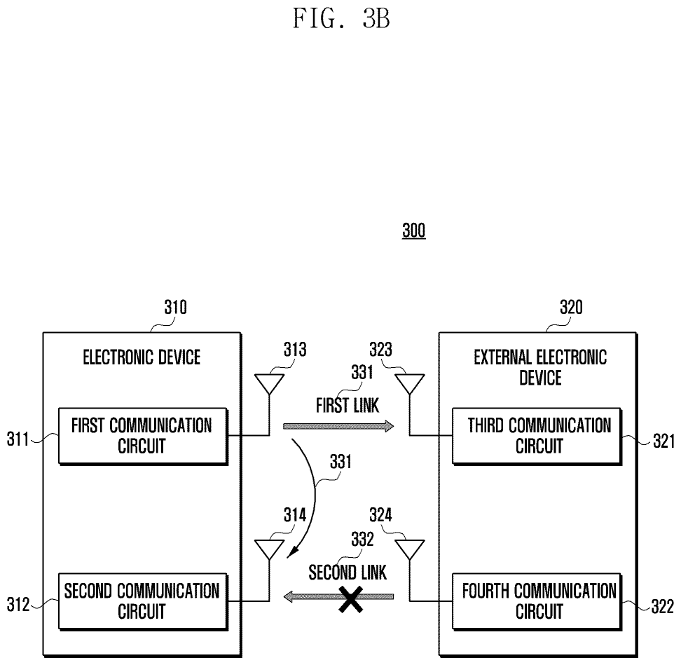

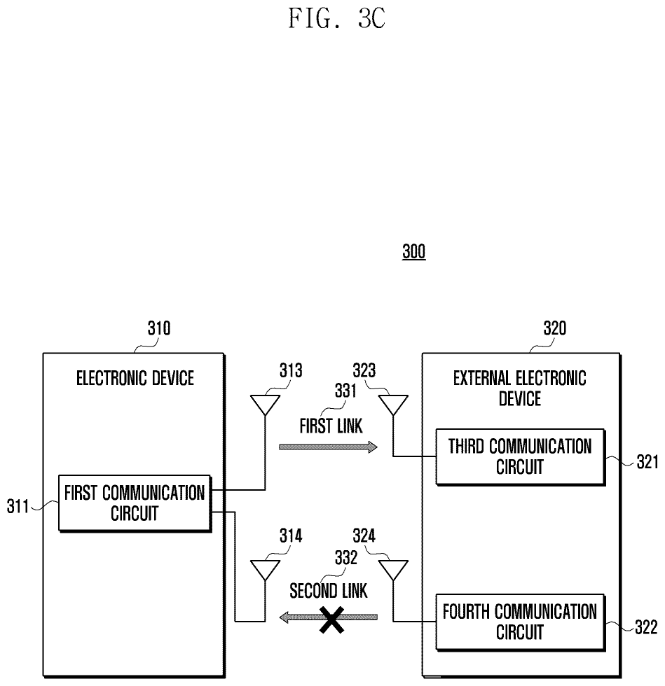

FIG. 3A illustrates an embodiment in which an electronic device and an access point (AP) operate in multi-link operation (MLO) according to an embodiment of the disclosure.

Referring to FIG. 3A, a wireless LAN system 300 may include an electronic device 310 and/or an external electronic device 320. According to an embodiment, the electronic device 310 may perform wireless communication with the external electronic device 320 through short-range wireless communication. Wireless communication may refer to various communication methods that both the electronic device 310 and/or the external electronic device 320 may support. For example, wireless communication may be Wi-Fi. The external electronic device 320 may function as a base station that provides wireless communication to at least one electronic device 310 located within the communication radius of a wireless LAN system 300. For example, the external electronic device 320 may include an access point (AP) of IEEE 802.11. The electronic device 310 may include a station (STA) of IEEE 802.11.

The electronic device 310 and/or the external electronic device 320 may support multi-link operation (MLO). Multi-link operation may be an operation method in which data is transmitted or received through multiple links (e.g., the first link 331 and the second link 332). Multi-link operation is an operating mode scheduled to be introduced in IEEE 802.11be and may be an operation method in which data is transmitted or received through multiple links based on multiple bands or channels.

In an embodiment, the electronic device 310 may include multiple communication circuits (e.g., a first communication circuit 311 and/or a second communication circuit 312) to support multi-link operations. The first communication circuit 311 may transmit data to the external electronic device 320 through a first link 331, or receive data transmitted by the external electronic device 320 through the first link 331. The first communication circuit 311 may output or receive a signal in the frequency band corresponding to the first link 331 through a first antenna 313. The second communication circuit 312 may transmit data to the external electronic device 320 through a second link 332, or receive data transmitted by the external electronic device 320 through the second link 332. The second communication circuit 312 may output or receive a signal in the frequency band corresponding to the second link 332 through a second antenna 314.

In another embodiment, the external electronic device 320 may include multiple communication circuits (e.g., a third communication circuit 321 and/or a fourth communication circuit 322) to support multi-link operations. The third communication circuit 321 may transmit data to the electronic device 310 through the first link 331 or receive data transmitted by the electronic device 310 through the first link 331. The third communication circuit 321 may output or receive a signal in the frequency band corresponding to the first link 331 through a third antenna 323. The fourth communication circuit 322 may transmit data to the electronic device 310 through the second link 332 or receive data transmitted by the electronic device 310 through the second link 332. The fourth communication circuit 322 may output or receive a signal in the frequency band corresponding to the second link 332 through a fourth antenna 324.

The frequency band of the first link 331 and the frequency band of the second link 333 may be different from each other. For example, the frequency band of the first link 331 may be 2.5 GHZ, and the frequency band of the second link 332 may be 5 GHz or 6 GHz. Alternatively, the frequency band of the first link 331 and the frequency band of the second link 333 may be the same, but the channel number of the first link 331 and the channel number of the second link 333 may be different. In another example, the first link 331 may be channel 1 of the 2.4 GHz frequency band, and the second link 333 may be channel 12 of the 2.4 GHz frequency band.

FIG. 3B illustrates an embodiment in which an electronic device operates in a non-simultaneous transmission and reception (STR) mode according to an embodiment of the disclosure.

Referring to FIG. 3B, the wireless LAN system 300 may include an electronic device 310 and/or an external electronic device 320. According to one embodiment, the electronic device 310 may perform wireless communication with the external electronic device 320 through short-range wireless communication. Wireless communication may refer to various communication methods that both the electronic device 310 and/or the external electronic device 320 may support. For example, wireless communication may be Wi-Fi. The external electronic device 320 may function as a base station that provides wireless communication to at least one electronic device 310 located within the communication radius of the wireless LAN system 300. For example, the external electronic device 320 may include an access point (AP) of IEEE 802.11. The electronic device 310 may include a station (STA) of IEEE 802.11.

The electronic device 310 and/or the external electronic device 320 may support multi-link operation (MLO). Multi-link operation may be an operation method in which data is transmitted or received through multiple links (e.g., the first link 331 and the second link 332). Multi-link operation may be an operating mode scheduled to be introduced in IEEE 802.11be and may be an operation method in which data is transmitted or received through multiple links based on multiple bands or channels.

According to another embodiment, the electronic device 310 may include multiple communication circuits (e.g., a first communication circuit 311 and/or a second communication circuit 312) to support multi-link operations. The first communication circuit 311 may transmit data to the external electronic device 320 through the first link 331, or receive data transmitted by the external electronic device 320 through the first link 331. The first communication circuit 311 may output or receive a signal in the frequency band corresponding to the first link 331 through the first antenna 313. The second communication circuit 312 may, for example, transmit data to the external electronic device 320 through the second link 332, or receive data transmitted by the external electronic device 320 through the second link 332. The second communication circuit 312 may output or receive a signal in the frequency band corresponding to the second link 332 through the second antenna 314.

The external electronic device 320 may include multiple communication circuits (e.g., a third communication circuit 321 and/or a fourth communication circuit 322) to support multi-link operations. The third communication circuit 321 may transmit data to the electronic device 310 through the first link 331 or receive data transmitted by the electronic device 310 through the first link 331. The third communication circuit 321 may output or receive a signal in the frequency band corresponding to the first link 331 through the third antenna 323. The fourth communication circuit 322 may transmit data to the electronic device 310 through the second link 332 or receive data transmitted by the electronic device 310 through the second link 332. The fourth communication circuit 322 may output or receive a signal in the frequency band corresponding to the second link 332 through the fourth antenna 324.

According to various embodiments of the disclosure, the frequency band of the first link 331 and the frequency band of the second link 333 may be different from each other. For example, the frequency band of the first link 331 may be 2.5 GHZ, and the frequency band of the second link 332 may be 5 GHZ. Alternatively, the frequency band of the first link 331 and the frequency band of the second link 333 may be the same, but the channel number of the first link 331 and the channel number of the second link 333 may be different. For example, the first link 331 may be channel 1 of the 2.4 GHz frequency band, and the second link 333 may be channel 12 of the 2.4 GHZ frequency band.

The electronic device 310 may not sufficiently secure a space 431 between the first antenna 313 and the second antenna 314 due to implementation reasons. According to another embodiment, when the space 431 between the first antenna 313 and the second antenna 314 is not sufficiently secured, the signal output from the first antenna 313 and the signal received through the second antenna 314 may interfere with each other. For example, the second antenna 314 may receive a signal in which the signal received through the second link 332 and a portion of the signal output from the first antenna 313 are combined, thereby causing the quality of the signal received through the second link 332 to deteriorate.

The electronic device 310 may support non-simultaneous transmission and reception (STR) mode to prevent the situation where the signal output from the first antenna 313 and the signal output from the second antenna 314 interfere with each other. The non-STR mode may, for example, refer to a mode in which the electronic device 310 does not receive data through the second link 332 at the time of transmitting data to the external electronic device 320 through the first link 331. The non-STR mode may support the operation of receiving data through the second link 332 while data is received through the first link 331 and/or the operation of transmitting data through the second link 332 while data is transmitted through the first link 331.

FIG. 3C illustrates an embodiment in which an electronic device operates in an enhanced multi-link with single radio (EMLSR) mode according to an embodiment of the disclosure.

Referring to FIG. 3C, the wireless LAN system 300 may include an electronic device 310 and/or an external electronic device 320. According to an embodiment, the electronic device 310 may perform wireless communication with an external electronic device 320 through short-range wireless communication. Wireless communication may refer to various communication methods that both the electronic device 310 and/or the external electronic device 320 may support. For example, wireless communication may be Wi-Fi. The external electronic device 320 may function as a base station that provides wireless communication to at least one electronic device 310 located within the communication radius of the wireless LAN system 300. For example, the external electronic device 320 may include an access point (AP) of IEEE 802.11. The electronic device 310 may include a station (STA) of IEEE 802.11.

In an embodiment, the electronic device 310 and/or the external electronic device 320 may support multi-link operation (MLO). Multi-link operation may be an operation method in which data is transmitted or received through multiple links (e.g., the first link 331 and the second link 332). Multi-link operation is an operating mode scheduled to be introduced in IEEE 802.11be and may be an operation method in which data is transmitted or received through multiple links based on multiple bands or channels.

In another embodiment, the electronic device 310 may include a first communication circuit 311 to support multi-link operations. The first communication circuit 311 may transmit data to the external electronic device 320 through the first link 331, or may receive data transmitted by the external electronic device 320 through the first link 331. The first communication circuit 311 may transmit data to the external electronic device 320 through the second link 332, or may receive data transmitted by the external electronic device 320 through the second link 332. The first communication circuit 311 may output or receive a signal in the frequency band corresponding to the first link 331 through the first antenna 313, and may output or receive a signal in the frequency band corresponding to the second link 332 through the second antenna 314.

The external electronic device 320 may include multiple communication circuits (e.g., a third communication circuit 321 and/or a fourth communication circuit 322) to support multi-link operations. The third communication circuit 321 may, for example, transmit data to the electronic device 310 through the first link 331 or receive data transmitted by the electronic device 310 through the first link 331. The third communication circuit 321 may output or receive a signal in the frequency band corresponding to the first link 331 through the third antenna 323. The fourth communication circuit 322 may transmit data to the electronic device 310 through the second link 332 or receive data transmitted by the electronic device 310 through the second link 332. The fourth communication circuit 322 may output or receive a signal in the frequency band corresponding to the second link 332 through the fourth antenna 324.

According to various embodiments of the disclosure, the frequency band of the first link 331 and the frequency band of the second link 333 may be different from each other. For example, the frequency band of the first link 331 may be 2.5 GHZ, and the frequency band of the second link 332 may be 5 GHZ. Alternatively, the frequency band of the first link 331 and the frequency band of the second link 333 may be the same, but the channel number of the first link 331 and the channel number of the second link 333 may be different. In an example, the first link 331 may be channel 1 of the 2.4 GHz frequency band, and the second link 333 may be channel 12 of the 2.4 GHZ frequency band.

According to various embodiments of the disclosure, the electronic device 310 may, for implementation reasons, support a multi-link operation in which multiple links are used by one communication circuit (e.g., the first communication circuit 311). In this case, the electronic device 310 may perform an enhanced multi-link single radio (EMLSR) mode, in which data of relatively small size (e.g., control data, RTS frame, CTS frame, ACK message) may be transmitted using multiple links (e.g., the first link 331 and the second link 332) while data of relatively large size is transmitted through a single link (e.g., the first link 331). The EMLSR mode may refer to a mode in which data of relatively small size is transmitted/received using multiple links, and data of relatively large size is transmitted/received using a single link. When relatively large size data is transmitted to the external electronic device 320 through the first link 331, the electronic device 310 operating in the EMLSR mode may not receive data through the second link 333.

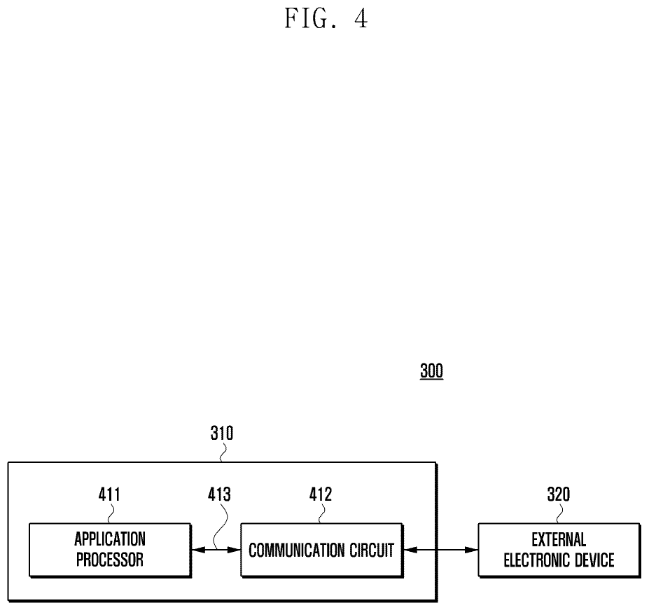

FIG. 4 illustrates an embodiment in which an electronic device is connected to an external electronic device through short-range wireless communication according to an embodiment of the disclosure.

Referring to FIG. 4, the wireless LAN system 300 may include an electronic device 310 and/or an external electronic device 320. According to an embodiment, the electronic device 310 may perform wireless communication with an external electronic device 320 through short-range wireless communication. Short-distance wireless communication may refer to various communication methods that both the electronic device 310 and/or the external electronic device 320 may support. In an example, short-range wireless communication may be Wi-Fi. The external electronic device 320 may function as a base station that provides wireless communication to at least one electronic device 310 located within the communication radius of the wireless LAN system 300. For example, the external electronic device 320 may include an access point (AP) of IEEE 802.11. The electronic device 310 may include a station (STA) of IEEE 802.11.

Short-distance wireless communication used by the electronic device 310 and/or the external electronic device 320 to exchange data may use various frequency bands, including a first frequency band (e.g., 2.4 GHZ), a second frequency band (e.g., 5 GHZ), a third frequency band (e.g., 6 GHZ), and/or a fourth frequency band (e.g., 7 GHz). The electronic device 310 and/or the external electronic device 320 may, for example, establish a channel included in one frequency band among multiple frequency bands and exchange data using the established channel.

The electronic device 310 and/or the external electronic device 320 may support various generations of short-range wireless communication. For example, the generation of short-range wireless communication supported by the electronic device 310 and/or the external electronic device 320 may be as shown in Table 1 below.

TABLE 1

| | Generation | | | | |
|---|---|---|---|---|---|
| | Wi-Fi 4 | Wi-Fi 5 | Wi-Fi 6 | Wi-Fi 6E | Wi-Fi 7 |
| Maximum data | 1.2 Gbps | 3.5 Gbps | 9.6 Gbps | | 46 Gbps |
| rate | | | | | |
| Frequency band | 2.4 GHz, | 5 GHz | 2.4 GHz, | 6 GHz | 1~7.25 GHz |
| | 5 GHz | | 5 GHz | | |

| Channel | 20, | 20, 40, 80, | 20, 40, 80, | Supportable |
|---|---|---|---|---|
| bandwidth | 40 MHz | 80 + 80, | 80 + 80, 160 MHz | up to 320 MH |
| | | 160 MHz | | |
| Modulation | 64 QAM | 256 QAM | 1024 QAM OFDMA | 4096QAM |
| coding scheme | OFDM | OFDM | | OFDMA |
| (MCS) | | | | |
| Multiple input | 4 × 4 | 4 × 4 MIMO, | 8 × 8 UL/DL | 16 × 16 |
| multiple output | MIMO | DL MU- | MU-MIMO | MU-MIMO |
| (MIMO) | | MIMO | | |

In an embodiment, when the electronic device 310 is capable of supporting short-range wireless communication (e.g., Wi-Fi 7) capable of transmitting and/or receiving data through multiple links, the electronic device 310 may transmit and/or receive data to and/or from the external electronic device 320 through multiple links.

As part of the process of connecting to the external electronic device 320, the electronic device 310 may transmit, to the external electronic device 320, a channel generation request message related to short-range wireless communication (e.g., a beacon message or a probe response message, which is a response message corresponding to a probe message transmitted by the external electronic device 320).

In response to the channel generation request message, the external electronic device 320 may transmit, to the electronic device 310, a message including information related to short-range wireless communication that the external electronic device 320 is capable of supporting.

The information related to short-range wireless communication may include information regarding the generation of short-range wireless communication (e.g., Wi-Fi 4, Wi-Fi 5, Wi-Fi 6, Wi-Fi6e, and/or Wi-Fi 7) supported by the external electronic device 320, channel bandwidth information, information indicating the maximum data rate, and/or information indicating the modulation and coding scheme (MCS).

In an embodiment, the information related to short-range wireless communication may include information indicating whether the external electronic device 320 supports short-range wireless communication capable of transmitting and/or receiving data through multiple links.

The information related to short-range wireless communication may, when the external electronic device 320 supports short-range wireless communication capable of transmitting and/or receiving data through multiple links, include information related to multiple links (e.g., identification information of APs supporting the respective multiple links, bandwidth information of each of the multiple links, and MCS level of data to be transmitted or received through the multiple links).

The electronic device 310 may configure a channel to be connected to the external electronic device 320, based on information related to short-range wireless communication transmitted by the external electronic device 320.

In an embodiment, the electronic device 310 may receive information related to short-range wireless communication transmitted by the external electronic device 320, and may identify whether the external electronic device 320 supports short-range wireless communication capable of transmitting and/or receiving data through multiple links.

When it is identified that the external electronic device 320 supports short-range wireless communication capable of transmitting and/or receiving data through multiple links, the electronic device 310 may select at least one link among the multiple links as the link to be used to transmit and/or receive data.

In another embodiment, the electronic device 310 may select at least one link to transmit and/or receive data, and transmit an association request frame including information related to the selected link (e.g., capability information of the selected link, parameters related to the operation of the selected link (operational parameters)) to the external electronic device 320. The association request frame may be a signal requesting activation of the selected link.

The external electronic device 320 may receive the association request frame transmitted by the electronic device 310 and identify the link selected by the electronic device 310 and included in the association request frame. The external electronic device 320 may, for example, determine whether the link selected by the electronic device 310 is activated and transmit, to the electronic device 310, an association response frame including information indicating whether each selected link is activated.

The electronic device 310 may receive the association response frame transmitted by the external electronic device 320 and identify information indicating whether each selected link included in the association response frame is active. The electronic device 310 may activate at least one link, based on information indicating whether each selected link is activated.

When there are multiple activated links, the electronic device 310 may transmit data to the external electronic device 320 through multiple links, or may receive, through multiple links, data transmitted by the external electronic device 320.

A mode (e.g., multi-link operation (MLO)) of transmitting or receiving data through multiple links may include a mode in which simultaneous data transmission through multiple links is possible (e.g., multi-link multi-radio (MLMR), enhanced multi-link multi-radio (EMLMR)) and a mode in which data transmission through one of multiple links is possible (e.g., multi-link single-radio (MLSR), enhanced multi-link single-radio (EMLSR)).

In the process of configuring a channel, the electronic device 310 may configure an interface 413 between an application processor 411 (e.g., the processor 120 of FIG. 1) and a communication module 412 (e.g., the wireless communication module 192 of FIG. 1). The interface may be peripheral component interconnect express (PCIe). The PCIe may be a serial interface for data exchange between elements of the electronic device 310 (e.g., the application processor 411 and/or the communication module 412). The communication module 412 may process data received through the established channel from the external electronic device 320 (e.g., demodulate data according to a designated MCS and/or identify whether an error occurs in the data), and transmit the processed data to the application processor 411 through the interface 413. The application processor 411 may transmit the data to be transmitted to the communication module 412 through the interface 413. Alternatively, the application processor 411 may also transmit a control signal to control the communication module 412 through the interface 413.

The electronic device 310 may support an interface 413 supporting various modes. According to another embodiment, the interface 413 may support multiple operating modes that comply with the PCIe standard. The operating modes supported by the interface 413 may have different maximum data rates. For example, the interface 413 may support an operating mode according to the PCIe generation. The operating modes supported by the interface 413 implemented on the electronic device 310 are listed in Table 2 below.

TABLE 2

| | Operating mode | | | | |
|---|---|---|---|---|---|
| | First | Second | Third | Fourth | Fifth |
| | operating | operating | operating | operating | operating |
| | mode | mode | mode | mode | mode |
| PCIe | PCIe 1.0 | PCIe 2.0 | PCIe 3.0 | PCIe 4.0 | PCIe 5.0 |
| generation | (first | (second | (third | (fourth | (fifth |
| | generation) | generation) | generation) | generation) | generation) |
| Maximum | 2 Gbps | 4 Gbps | 7.88 Gbps | 16 Gbps | 32 Gbps |
| data rate | | | | | |

The interface 413 may support multiple operating modes that comply with the PCIe standard. Referring to Table 2, the interface 413 may support a first operating mode with a maximum data rate of 2 Gbps, a second operating mode with a maximum data rate of 4 Gbps, a third operating mode with a maximum data rate of 7.88 Gbps, a fourth operating mode with a maximum data rate of 16 Gbps, and/or a fifth operating mode with a maximum data rate of 32 Gbps. The interface 413 may operate in any one of multiple operating modes, based on control of the application processor 411 and/or the communication module 412.

The electronic device 310 may transmit and/or receive data at a specific data rate while being connected to the external electronic device 320 through a channel. When the electronic device 310 transmits and/or receives data through the interface 311 operating in an operating mode (e.g., a first operating mode) having a data rate (e.g., 2 Gbps) lower than a specific data rate (e.g., 3 Gbps), a bottleneck occurs where a portion of the data cannot be transmitted and/or received within a predetermined time. When the bottleneck occurs, the data transmission or reception rate may decrease, and furthermore, unnecessary power consumption may occur. In addition, when the electronic device 310 transmits and/or receives data through the interface 413 operating in an operating mode (e.g., a fourth operating mode) having a relatively higher data rate (e.g., 7.88 Gbps) than a specific data rate (e.g., 3 Gbps), a situation in which unnecessary power consumption may occur as compared to a case in which the electronic device 310 transmits and/or receives data through the interface 413 operating in an operating mode (e.g., a third operating mode) having a relatively lower data rate (e.g., 4 Gbps).

Embodiments for preventing bottlenecks and reducing unnecessary power consumption by transmitting and/or receiving data through the appropriate interface 413 based on capability information of the external electronic device 320 are described.

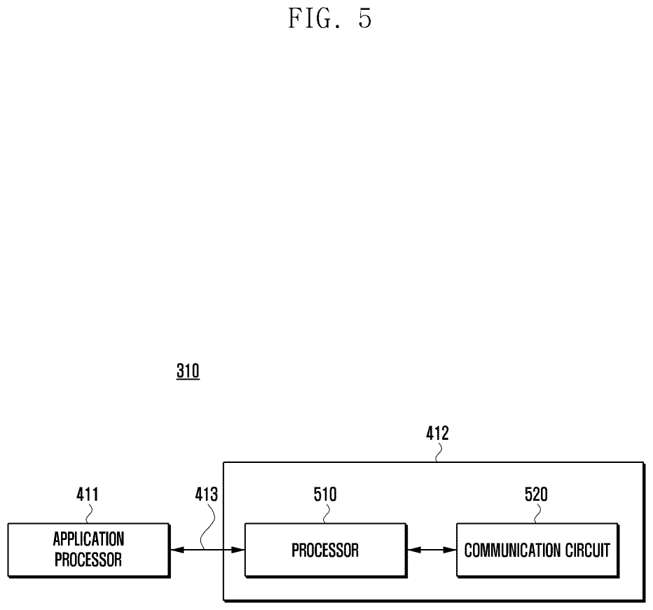

FIG. 5 is a block diagram of an electronic device according to an embodiment of the disclosure.

According to various embodiments of the disclosure, an electronic device (e.g., the electronic device 310 of FIGS. 3A, 3B, and 3C) may include an application processor 411 (e.g., the processor 120 of FIG. 1), a communication module 412 (e.g., the wireless communication module 192 of FIG. 1), and/or an interface 413.

The application processor 411 may receive data transmitted by an external electronic device (e.g., the external electronic device 320 of FIGS. 3A, 3B, and 3C) through the communication module 412 and perform various operations using the received data. The application processor 411 may transmit data to the communication module 412 through the interface 413 to transmit the data to the external electronic device 320.

The interface 413 is an element implemented between the application processor 411 and the communication module 412, and may transmit data, transmitted by the application processor 411, to the communication module 412 and transmit data, transmitted by the communication module 412, to the application processor 411. The interface may be peripheral component interconnect express (PCIe). The PCIe may be a serial interface for data exchange between elements of the electronic device 310 (e.g., the application processor 411 and/or the communication module 412).

The application processor 411 and/or the processor 510 may support an interface 413 supporting various modes. The interface 413 may support multiple operating modes that comply with the PCIe standard. The operating modes supported by the interface 413 may have different maximum data rates. For example, the interface 413 may support an operating mode according to the PCIe generation. The operating modes supported by the interface 413 implemented on the electronic device 310 are listed in Table 2 above. The interface 413 may, for example, support multiple operating modes that comply with the PCIe standard. Referring to Table 2, the interface 413 may support a first operating mode with a maximum data rate of 2 Gbps, a second operating mode with a maximum data rate of 4 Gbps, a third operating mode with a maximum data rate of 7.88 Gbps, a fourth operating mode with a maximum data rate of 16 Gbps, and/or a fifth operating mode with a maximum data rate of 32 Gbps. The interface 413 may operate in one of multiple operating modes, based on control of the application processor 411 and/or the processor 510.

The communication module 412 is connected to the application processor 312 through the interface 413 to exchange data. The communication module 412 may include various elements to support short-range wireless communication (e.g., Wi-Fi). According to an embodiment, the communication module 412 may include a processor 510 and/or a communication circuit 520.

The communication circuit 520 may include various circuit structures used for modulating and/or demodulating signals within electronic device 310. For example, the communication circuit 520 may modulate a baseband signal into a radio frequency (RF) band signal to be output through an antenna (not shown), or may demodulate an RF band signal received through the antenna into a baseband signal and transmit the same to the processor 510.

According to some embodiments of the disclosure, the processor 510 may perform various operations to receive data transmitted by the application processor 411 through the interface 413 and transmit the received data to the external electronic device 320. The processor 510 may be defined as a communication processor included in the communication module 412. According to an embodiment, the processor 510 may perform channel coding based on data transmitted by the application processor 411, identify whether at least part of the data transmitted by the external electronic device 320 has an error, or, if an error occurs, perform an operation to recover the error (e.g., hybrid auto-repeat request (HARQ)).

According to other embodiments of the disclosure, the processor 510 may receive capability information of the external electronic device 320 as part of an operation to establish a channel for exchanging data with the external electronic device 320. The processor 510 may transmit, to the external electronic device 320, a channel generation request message related to short-range wireless communication (e.g., a beacon message or a probe response message, which is a response message corresponding to a probe message transmitted by the external electronic device 320). The external electronic device 320 may receive the channel generation request message from the electronic device 310 and transmit a response message including capability information of the external electronic device 320 to the electronic device 310.

The capability information of the external electronic device 320 may be capability information related to short-range wireless communication supported by the external electronic device 320.

The capability information of the external electronic device 320 may include information regarding the generation of short-range wireless communication (e.g., Wi-Fi 4, Wi-Fi 5, Wi-Fi 6, Wi-Fi6e, and/or Wi-Fi 7) supported by the external electronic device 320, channel bandwidth information, information indicating the maximum data rate, and/or information indicating the modulation and coding scheme (MCS).

For example, the capability information of the external electronic device 320 may include information indicating whether the external electronic device 320 supports short-range wireless communication capable of transmitting and/or receiving data through multiple links.

When the external electronic device 320 supports short-range wireless communication capable of transmitting and/or receiving data through multiple links, the capability information of the external electronic device 320 may include information related to multiple links (e.g., identification information of APs supporting each of multiple links, bandwidth information of each of the multiple links, MCS level of data to be transmitted or received through the multiple links, and/or the number of spatial streams (N_{SS}) of each of the multiple links). When the external electronic device 320 supports enhanced multi-link multi-radio (EMLMR) or enhanced multi-link single-radio (EMLSR), the number of spatial streams for each of the multiple links may be included in a frame (e.g., an EML operating mode notification frame) that indicates support for the EMLMR or EMLSR mode defined in the EMLMR or EMLSR.

The processor 510 may, for example, receive capability information of the external electronic device 320 and establish a link to be connected to the external electronic device 320, based on the capability information of the external electronic device 320.

The processor 510 may, based on the capability information of the external electronic device 320, identify whether the external electronic device 320 supports short-range wireless communication capable of transmitting and/or receiving data through multiple links. Based on the information included in the capability information of the external electronic device 320 and indicating whether the external electronic device 320 supports short-range wireless communication capable of transmitting and/or receiving data through multiple links, the processor 510 may identify whether the external electronic device 320 supports short-range wireless communication capable of transmitting and/or receiving data through multiple links.

When it is identified that the external electronic device 320 supports short-range wireless communication capable of transmitting and/or receiving data through multiple links, the processor 510 may select at least one link among the multiple links as a link to be used for transmitting and/or receiving data.

As part of the operation of establishing a link, the processor 510 may determine characteristics of the selected link, based on capability information of the external electronic device 320. Determining the characteristics of the selected link may be performed after selecting a link to be activated or during the procedure of selecting a link to be activated. The characteristics of the link may include the size of the bandwidth of the link, the MCS level of data to be transmitted or received through the link, and/or the number of spatial streams.

According to another example, the processor 510 may identify the information related to the selected link and included in the capability information of the external electronic device 320 (e.g., identification information of APs supporting each of the multiple links, bandwidth information of each of the multiple links, the MCS level of data to be transmitted or received through the multiple links, and the number of spatial streams (N_{SS}) of each of the multiple links), and may determine the characteristics of the link by considering the capability that the electronic device 310 can support.

The processor 510 may select at least one of multiple links, determine characteristics of the selected link, and transmit a signal (e.g., an association request frame) including information indicating the selected link and information related to the selected link to the external electronic device 320. The association request frame may be a signal requesting activation of the selected link. Information related to the selected link may include characteristics of the selected link.

The external electronic device 320 may receive the association request frame transmitted by the electronic device 310 and identify the link selected by the electronic device 310 and included in the association request frame. The external electronic device 320 may determine whether the link selected by the electronic device 310 is activated and transmit an association response frame including information indicating whether each selected link is activated to the electronic device 310.

In an embodiment, the processor 510 may receive the association response frame transmitted by the external electronic device 320 and identify the information included in the association response frame and indicating whether each selected link is activated. The processor 510 may activate at least one link, based on the information indicating whether each selected link is activated.

In an example, the processor 510 may receive a configuration to be used by the external electronic device 320 for short-range wireless communication determined based on the capability information of the electronic device 310 and the capability information of the external electronic device 320. When the processor 510 receives a configuration to be used for short-range wireless communication determined by the external electronic device 320, the procedure of selecting a link and/or determining the characteristics of the link by the processor 510 may be omitted.

The processor 510 may control the communication circuit 520, based on information indicating whether each selected link is activated and the characteristics of the selected link.

According to another embodiment, the processor 510 may control the communication circuit 520 in a manner of activating specific elements (e.g., an amplifier for amplifying a signal in a specific frequency band and/or a filter for filtering a signal in a specific frequency band) included in the communication circuit 520 to transmit or receive data through a specific frequency band included in the characteristics of the selected link and the information indicating whether each of the selected links is activated.

The processor 510 may control the interface 413 to perform short-range wireless communication. The processor 510 may identify the maximum data rate of data to be transmitted or received through multiple links activated between the electronic device 310 and the external electronic device 320, and select, based on the maximum data rate, an operating mode in which the interface 413 is to operate.

The processor 510 may, for example, identify the maximum data rate of the data to be transmitted or received through each of the multiple links in order to identify the maximum data rate of the data to be transmitted or received through the multiple links activated between the electronic device 310 and the external electronic device 320.

The processor 510 may, based on the characteristics of the selected link, identify the maximum data rate of data to be transmitted or received through each of the multiple links. The processor 510 may identify the maximum data rate of data to be transmitted or received through each of the multiple links by referring to mapping data in which the link characteristics and maximum data rate are mapped.

For example, the mapping data may be implemented as shown in Table 3 below and may be stored in the memory of the electronic device 310 (e.g., the memory 130 of FIG. 1). Table 3 shows mapping data including the MCS level defined in IEEE 802.11 ax and the data rate mapped to the MCS level.

TABLE 3

| MCS level | Maximum data rate (Mbps) |
|---|---|
| 11(1024QAM, coding rate 5/6) | 1147.1 Mbps |
| 10(1024QAM, coding rate 3/4) | 1032.4 Mbps |
| 9(255QAM, coding rate 5/6) | 917.6 Mbps |
| . . . | . . . |
| 3(16QAM, coding rate 3/4) | 275.3 Mbps |
| 2(QPSK, coding rate 3/4) | 206.5 Mbps |
| 1(QPSK, coding rate 1/2) | 206.5 Mbps |
| 0(BPSK, coding rate 1/2) | 68.8 Mbps |

The mapping data shown in Table 3 is an example, and data for which at least one of the various characteristics of the link (e.g., size of bandwidth, MCS level, number of spatial streams) and maximum data rate are mapped may all be included in the mapping data.

According to an example, a first link (e.g., the first link 331 of FIG. 3A) and a second link (e.g., the second link 332 of FIG. 3A) are activated between the electronic device 310 and the external electronic device 320, and when the processor 510 determines the MCS level of the data to be transmitted or received through the first link 331 as 11, the data to be transmitted or received through the first link 331 may have a maximum data rate of 1147.1 Mbps.

According to an example, a first link (e.g., first link 331 of FIG. 3A) and a second link (e.g., second link 332 of FIG. 3A) are activated between the electronic device 310 and the external electronic device 320, and when the processor 510 determines the MCS level of the data to be transmitted or received through the second link 332 as 10, the data to be transmitted or received through the second link 332 may have a maximum data rate of 1032.4 Mbps.

The processor 510 may identify the maximum data rate of each of the multiple links to be activated between the electronic device 310 and the external electronic device 320, and identify the maximum data rate of the multiple links, based on the operating mode for short-range wireless communication. The maximum data rate of the multiple links may mean the maximum data rate of data transmitted by the electronic device 310 to the external electronic device 320.

The operating mode for short-range wireless communication may include a mode (e.g., multi-link operation (MLO)) of transmitting or receiving data through multiple links. A mode (e.g., multi-link operation (MLO)) of transmitting or receiving data through multiple links may include a mode in which simultaneous data transmission through multiple links is possible (e.g., multi-link multi-radio (MLMR), enhanced multi-link multi-radio (EMLMR)) and a mode in which data transmission through one of multiple links is possible (e.g., multi-link single-radio (MLSR), enhanced multi-link single-radio (EMLSR)). When the electronic device 310 operates in a mode in which simultaneous data transmission is possible through multiple links, the electronic device 310 may transmit data through one link while data transmission through another link is performed. When the electronic device 310 operates in a mode in which data transmission is possible through one of multiple links, the electronic device 310 may not be able to transmit data through another link while data transmission through one link is performed.

In an embodiment, when the electronic device 310 operates in a mode in which data transmission through multiple links is possible, the processor 510 may determine, as the maximum data rate of multiple links, the sum of the maximum data rates of each of the multiple links generated between the electronic device 310 and the external electronic device 320. A mode in which the electronic device 310 is capable of simultaneously transmitting data through multiple links is a mode in which simultaneous data transmission through multiple links is possible, and in which the sum of the maximum data rates of each of the multiple links may be the maximum data rate of the multiple links.

According to an example, the processor 510 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through multiple links is possible, the processor 510 may determine, as the maximum data rate (e.g., 2179.5 Mbps) of multiple links, the sum of the maximum data rates (e.g., 1147.1 Mbps+1032.4 Mbps) of each of the multiple links generated between the electronic device 310 and the external electronic device 320.

In another embodiment, when the electronic device 310 operates in a mode in which data transmission through one of multiple links is possible, the processor 510 may determine, as the maximum data rate of the multiple links, the largest data rate among the maximum data rates of each of the multiple links generated between the electronic device 310 and the external electronic device 320.

A mode in which the electronic device 310 is capable of transmitting data through one of multiple links is a mode in which while data transmission through one of the multiple links is performed, data transmission through another link is impossible, and in which the largest value among the maximum data rates of each of the multiple links may be the maximum data rate of multiple links.

In an example, the processor 510 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through one of multiple links is possible, the processor 510 may determine, as the maximum data rate (e.g., 1147.1 Mbps) of multiple links, the largest value (e.g., the maximum data rate 1147.1 Mbps of the first link 331) among the maximum data rates of each of the multiple links (e.g., the maximum data rate 1147.1 Mbps of the first link 331 and the maximum data rate 1032.4 Mbps of the second link 332) generated between the electronic device 310 and the external electronic device 320.

The processor 510 may determine the maximum data rate of the multiple links, based on the operating mode for short-range wireless communication, and may select one of the multiple operating modes of the interface 413, based on the maximum data rate of the multiple links.

The processor 510 may select an operating mode that supports a data rate higher than the maximum data rate, as the operating mode in which the interface 413 is to operate. For example, the processor 510 may select one of operating modes (e.g., a second operating mode, a third operating mode, a fourth operating mode, and/or a fifth operating mode) that supports a data rate higher than the maximum data rate (e.g., 2179.5 Mbps) of the multiple links, as the operating mode in which the interface 413 is to operate. According to another embodiment, the processor 510 may select an operating mode (e.g., a second operating mode) having the lowest maximum data rate among operating modes that support a data rate higher than the maximum data rate of multiple links, as the operating mode in which the interface 413 is to operate, thereby preventing bottlenecks and reducing power consumption.

In response to identifying that the interface 413 is operating in an operating mode different from the selected operating mode, the processor 510 may control the interface 413 to operate in the selected operating mode. The processor 510 may control the interface 413 to transition the state of the interface 413 from an active state (e.g., LO, L0s, or L1) to a recovery state, and to change the operating mode in the recovery state. The recovery state may be a temporarily transitioned state to change the operating mode of the interface 413. The processor 510 may, for example, change the operating mode of the interface 413 after the authentication operation between the external electronic device 320 and the electronic device 310 has been completed during the operation of activating multiple links between the external electronic device 320 and the electronic device 310, after receiving an association response frame, or during the generation and/or transmission of an association request frame. In response to the completion of the transition of the operating mode of the interface 413, the processor 510 may perform various operations for establishing a channel (e.g., an association operation between an external electronic device 320 and the electronic device 310) and complete the activation operation of multiple links.

The processor 510 may receive data, transmitted by the application processor 411, through the interface 413 operating in the selected operating mode and transmit the data to the external electronic device 320. Alternatively, the processor 510 may transmit data, transmitted by the external electronic device 320, to the application processor 411 through the interface 413 operating in the selected operating mode.

When it is detected that the state of at least one link among the multiple activated links between the electronic device 310 and the external electronic device 320 changes, the processor 510 may re-identify the maximum data rate of the multiple links (alternatively, it may identify whether the maximum data rate of multiple links has changed).

The processor 510 may, based on a traffic identifier (TID) to link mapping frame transmitted by the application processor 411, identify whether the state of at least one of multiple links activated between the electronic device 310 and the external electronic device 320 changes.

The TID to link mapping frame may be data indicating a link on which data with a specific TID is to be transmitted or received. The TID to link mapping frame may be data in which a TID and a link through which the TID is to be transmitted or received are mapped to each other. The processor 510 may receive the TID to link mapping frame and, based on identifying that at least one link among the multiple links is not included in the TID to link mapping frame, may identify that the at least one link has transitioned from the active state to the inactive state. Alternatively, the processor 510 may receive the TID to link mapping frame and, based on identifying that at least one link among the multiple links is newly included in the TID to link mapping frame, may identify that the at least one link has transitioned from the inactive state to the active state.

The processor 510 may, upon detecting a change in the power mode, identify whether the state of at least one link among the multiple links has changed. The processor 510 may identify whether the power mode is changed, based on information transmitted by the external electronic device 320 and included in the frame for controlling the power mode, the information indicating whether the power saving mode is active or not. According to an example, in a state in which the power saving mode is active, when the processor 510 receives a frame for controlling the power mode and including information indicating a state in which the power saving mode is inactive, the processor 510 may transition at least one of multiple links from an inactive state to an active state.

In an embodiment, when it is detected that the state of at least one of the activated multiple links between the electronic device 310 and the external electronic device 320 has changed, the processor 510 may re-identify the maximum data rate of the multiple links (or identify whether the maximum data rate of the multiple links has changed) and, when the maximum data rate has changed, may change (or maintain) the operating mode of the interface 413 according to the changed maximum data rate.

The processor 510 may identify that the changed maximum data rate (e.g., 3000 Mbps) is greater than the maximum data rate (e.g., 2 Gbps) of the current operating mode (e.g., first operating mode) of the interface 413, and may control the interface 413 to operate in one of operating modes (e.g., a second operating mode, a third operating mode, a fourth operating mode, and/or a fifth operating mode) that support a data rate greater than the changed maximum data rate. The processor 510 may select, as an operating mode in which the interface 413 is to operate, an operating mode (e.g., a second operating mode) having the lowest maximum data rate among operating modes that support a data rate greater than the maximum data rate of multiple links, thereby preventing bottlenecks and reducing power consumption.

In another embodiment, the processor 510 may support various wireless communication modes defined in short-range wireless communication. Various wireless communication modes may include a station (STA) mode in which the electronic device 310 receives or transmits data from or to various external electronic devices through the external electronic device 320, a peer-to-peer (P2P) mode (or Wi-Fi direct mode) in which the electronic device 310 is directly connected to an external electronic device (e.g., the external electronic device 102 of FIG. 1) to exchange data, and/or a mobile hot-spot (MHS) mode in which the electronic device 310 performs the role of an access point (AP). As the electronic device 310 simultaneously supports various wireless communication modes, the electronic device 310 may be connected to another external electronic device (e.g., the external electronic device 102 of FIG. 1) through a different mode (e.g., a P2P mode and/or an MHS mode) while being connected to the external electronic device 320 through the STA mode. In the case of simultaneous transmission of various wireless communication modes, the processor 510 may control the operating mode of the interface 413, based on a maximum data rate.

The processor 510 may, for example, detect a connection with another external electronic device (e.g., the external electronic device 102 of FIG. 1) through short-range wireless communication while being connected to the external electronic device 320. Since the processor 510 has detected a connection with another external electronic device 102 through short-range wireless communication, the processor 510 may request and receive capability information from the other external electronic device 102.

The capability information of the other external electronic device 102 may be capability information related to short-range wireless communication supported by the other external electronic device 102. For example, the capability information of the other external electronic device 102 may include information regarding the generation of short-range wireless communication (e.g., Wi-Fi 4, Wi-Fi 5, Wi-Fi 6, Wi-Fi6e, and/or Wi-Fi 7) supported by the other external electronic device 102, channel bandwidth information, information indicating the maximum data rate, and/or information indicating the modulation and coding scheme (MCS).

The processor 510 may, for example, receive capability information of the other external electronic device 102, and establish a link to be connected to the other external electronic device 102, based on the capability information of the other external electronic device 102.

In connection with performing short-range wireless communication with another external electronic device 102, the processor 510 may select a link to connect the electronic device 310 with the other external electronic device 102.

According to an example, the processor 510 may select one of multiple links, generated between the electronic device 310 and the external electronic device 320, as a link to connect the electronic device 310 with the other external electronic device 102.

After selecting a link, the processor 510 may determine characteristics of the selected link, based on capability information of the other external electronic device 102, as part of the operation of link configuration. Determining the characteristics of the selected link may be performed after selecting a link to be activated or during the procedure of selecting a link to be activated. According to an example, the characteristics of the link may include the size of the bandwidth of the link, the MCS level of data to be transmitted or received through the link, and/or the number of spatial streams.

The processor 510 may identify the information related to the selected link and included in the capability information of the other external electronic device 102 (e.g., identification information of APs supporting each of the multiple links, bandwidth information of each of the multiple links, the MCS level of data to be transmitted or received through the multiple links, and the number of spatial streams (N_{SS}) of each of the multiple links), and may determine the characteristics of the link by considering the capability that the electronic device 310 can support.

In another embodiment, the processor 510 may control the interface 413 to perform short-range wireless communication. The processor 510 may identify the maximum data rate of data to be transmitted or received through multiple links activated between the electronic device 310 and the external electronic device 320, and select an operating mode in which the interface 413 is to operate based on the maximum data rate.

According to an example, in the case of selecting one of multiple links, generated between the electronic device 310 and the external electronic device 320, as a link to connect the electronic device 310 with the other external electronic device 102, the processor 510 may determine, as the maximum data rate of the selected link, the larger value between the maximum data rate of the data transmitted and/or received through the selected link in the electronic device 310 and the external electronic device 320 and the maximum data rate of the data transmitted and/or received through the selected link in the electronic device 310 and the other external electronic device 102.

In an example, in case that a first link (e.g., the first link 331 of FIG. 3A) and a second link (e.g., the second link 332 of FIG. 3A) are active between the electronic device 310 and the external electronic device 320, and the second link 332 is active between the electronic device 310 and the other external electronic device 102, the processor 510 may, in connection with determining the maximum data rate of the second link 332, determine, as the maximum data rate of the selected link, the larger value between the maximum data rate of the data transmitted and/or received through the selected link in the electronic device 310 and the external electronic device 320 and the maximum data rate of the data transmitted and/or received through the selected link in the electronic device 310 and the other external electronic device 102.

Referring to Table 3, when the processor 510 determines the MCS level of the data to be transmitted to or received from the external electronic device 320 through the second link 332 as 10, the maximum data rate of the data transmitted and/or received through the second link 332 between the electronic device 310 and the external electronic device 320 may be 1032.4 Mbps. When the processor 510 determines the MCS level of the data to be transmitted to or received from the other external electronic device 102 through the second link 332 as 11, the maximum data rate of the data transmitted and/or received through the second link 332 between the electronic device 310 and the external electronic device 320 may be 1147.3 Mbps.

The processor 510 may determine, as the maximum data rate of the second link, the larger value (1147.3 Mbps) between the maximum data rate (1032.4 Mbps) of data transmitted and/or received through the second link 332, which is a link selected by the electronic device 310 and the external electronic device 320, and the maximum data rate (1147.3 Mbps) of data transmitted and/or received through the second link 332, which is a link selected by the electronic device 310 and the other external electronic device 102.

In an embodiment, the processor 510 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1147.1 Mbps of the second link 332). When the electronic device 310 operates in a mode in which data transmission through multiple links is possible, the processor 510 may determine, as the maximum data rate of multiple links, the sum of the maximum data rates of each of the multiple links generated between the electronic device 310 and the external electronic device 320. A mode in which the electronic device 310 is capable of transmitting data simultaneously through multiple links is a mode in which simultaneous data transmission through multiple links is possible, and in which the sum of the maximum data rates of each of the multiple links may be the maximum data rate of the multiple links. When the electronic device 310 operates in a mode in which data transmission through multiple links is possible, the processor 510 may determine, as the maximum data rate (e.g., 2294.2 Mbps) of multiple links, the sum of the maximum data rates (e.g., 1147.1 Mbps+1147.1 Mbps) of each of the multiple links generated between the electronic device 310 and the external electronic device 320.

When the electronic device 310 operates in a mode in which data transmission through one of multiple links is possible, the processor 510 may determine, as the maximum data rate of the multiple links, the largest data rate among the maximum data rates of each of the multiple links generated between the electronic device 310 and the external electronic device 320. According to an example, the processor 510 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through one of multiple links is possible, the processor 510 may determine, as the maximum data rate (e.g., 1147.1 Mbps) of the multiple links, the largest value (e.g., the maximum data rate 1147.1 Mbps of the first link 331) among the maximum data rates of each of the multiple links (e.g., the maximum data rate 1147.1 Mbps of the first link 331 and the maximum data rate 1032.4 Mbps of the second link 332) generated between the electronic device 310 and the external electronic device 320.

The processor 510 may determine the maximum data rate of the multiple links, based on the operating mode for short-range wireless communication, and select one of the multiple operating modes of the interface 413, based on the maximum data rate of the multiple links.

In an example, the processor 510 may select a link different from multiple links generated between the electronic device 310 and the external electronic device 320, as a link to connect the electronic device 310 with the other external electronic device 102.

In connection with determining the maximum data rate of the electronic device 310, the processor 510 may identify the maximum data rate of each of the multiple links generated between the electronic device 310 and the external electronic device 320 and the maximum data rate of each of at least one ink generated between the electronic device 310 and the other external electronic device 102.

The processor 510 may determine the maximum data rate of the electronic device 310, based on an operating mode for short-range wireless communication, and select one of multiple operating modes of the interface 413, based on the maximum data rate of the multiple links.

In an embodiment, when the electronic device 310 operates in a mode in which data transmission through multiple links is possible, the processor 510 may determine, as the maximum data rate of the multiple links, the sum of the maximum data rates of each of the multiple links generated between the electronic device 310 and the external electronic device 320 and the maximum data rates of each of at least one link generated between the electronic device 310 and the other external electronic device 102. A mode in which the electronic device 310 is capable of transmitting data simultaneously through multiple links is a mode in which simultaneous data transmission through multiple links is possible, and in which the sum of the maximum data rates of each of the multiple links may be the maximum data rate of the multiple links.

When the electronic device 310 operates in a mode in which data transmission through one of multiple links is possible, the processor 510 may determine, as the maximum data rate of the electronic device 301, the largest value among the maximum data rates of each of the multiple links generated between the electronic device 310 and the external electronic device 320 and the maximum data rates of each of at least one link generated between the electronic device 310 and the other external electronic device 102.

The processor 510 may determine the maximum data rate of the multiple links, based on the operating mode for short-range wireless communication, and may select one of the multiple operating modes of the interface 413, based on the maximum data rate of the multiple links.

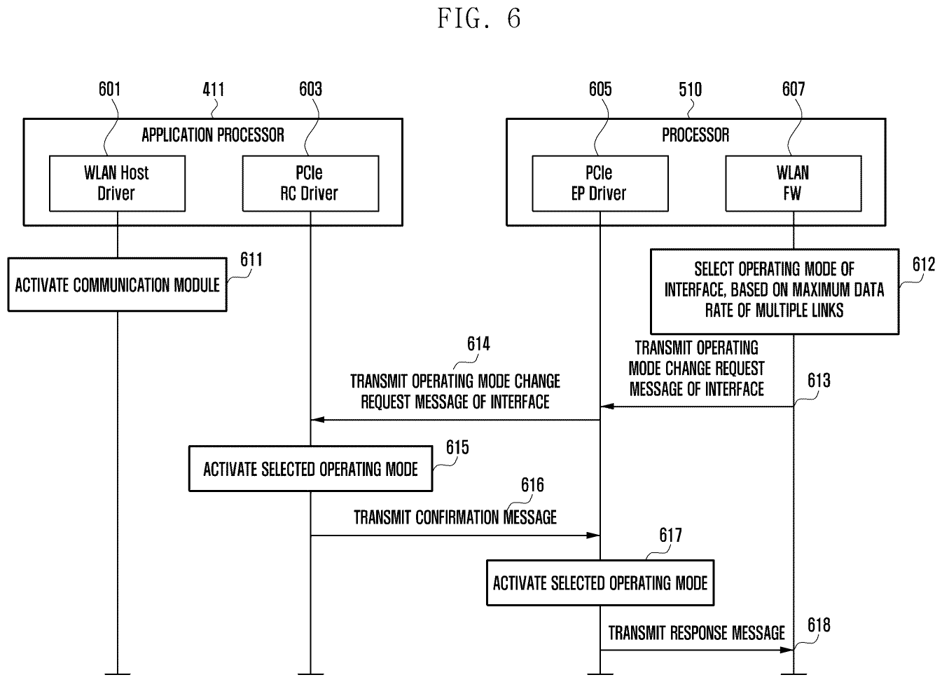

FIG. 6 illustrates an embodiment in which an electronic device connects an interface between an application processor and a communication module according to an embodiment of the disclosure.

An electronic device (e.g., the electronic device 310 of FIGS. 3A, 3B, and 3C) according to an embodiment may include an application processor 411 and a processor 510.

The application processor (e.g., the application processor 411 of FIG. 4) may include a wireless LAN (WLAN) host driver 601 that controls hardware configurations included in the communication module 312 and/or a PCIe route complex (RC) driver 603 that controls an interface (e.g., the interface 313 of FIG. 5).

The processor (e.g., the processor 510 of FIG. 4) may include a PCIe end-point (EP) driver 605 that controls the interface 313 and/or a WLAN firmware (FW) 607 that processes a control signal transmitted by the application processor 411 and controls hardware configurations included in the communication module 312 by using the result of the processing.

In operation 611, in response to meeting a particular condition (e.g., receiving a user input to activate short-range wireless communication, the electronic device 310 detecting a particular external electronic device (e.g., the external electronic device 320 of FIGS. 3A, 3B, and 3C), and/or identifying that the electronic device 310 enters a particular location), the WLAN host driver 601 may activate the communication module (e.g., the communication module 312 of FIG. 4).

As part of the operation of activating the communication module 312, the WLAN host driver 601 may transmit a signal indicating activation of the communication module 312 to the communication module 312 (or the processor 510) through the interface 313.

In response to receiving a signal that activates the communication module 312 and transmitted by the application processor 411 (or the WLAN host driver 601), the processor 510 may activate the communication circuit (e.g., the communication circuit 420 of FIG. 4) and perform an operation to connect to the external electronic device 320.

In an embodiment, the processor 510 may receive capability information of the external electronic device 320 as part of an operation to establish a channel for exchanging data with the external electronic device 320. The processor 510 may transmit, to the external electronic device 320, a channel generation request message related to short range wireless communication (e.g., a beacon message or a probe response message, which is a response message corresponding to a probe message transmitted by the external electronic device 320). The external electronic device 320 may receive a channel generation request message from the electronic device 310 and transmit a response message including capability information of the external electronic device 320 to the electronic device 310.

The capability information of the external electronic device 320 may be capability information related to short-range wireless communication supported by the external electronic device 320.

For example, the capability information of the external electronic device 320 may include information regarding the generation of short-range wireless communication (e.g., Wi-Fi 4, Wi-Fi 5, Wi-Fi 6, Wi-Fi6e, and/or Wi-Fi 7) supported by the external electronic device 320, channel bandwidth information, information indicating the maximum data rate, and/or information indicating the modulation and coding scheme (MCS).

In another example, the capability information of the external electronic device 320 may include information indicating whether the external electronic device 320 supports short-range wireless communication capable of transmitting and/or receiving data through multiple links.

For example, when the external electronic device 320 supports short-range wireless communication capable of transmitting and/or receiving data through multiple links, the capability information of the external electronic device 320 may include information related to multiple links (e.g., identification information of APs supporting each of multiple links, bandwidth information of each of the multiple links, MCS level of data to be transmitted or received through the multiple links, and/or the number of spatial streams (N_{SS}) of each of the multiple links). When the external electronic device 320 supports enhanced multi-link multi-radio (EMLMR) or enhanced multi-link single-radio (EMLSR), the number of spatial streams for each of the multiple links may be included in a frame (e.g., an EML operating mode notification frame) that indicates support for the EMLMR or EMLSR mode defined in the EMLMR or EMLSR.

The WLAN FW 607 may receive capability information of the external electronic device 320 and establish a link to be connected to the external electronic device 320, based on the capability information of the external electronic device 320.

The WLAN FW 607 may, based on the capability information of the external electronic device 320, identify whether the external electronic device 320 data through multiple links. Based on the information included in the capability information of the external electronic device 320 and indicating whether the external electronic device 320 supports short-range wireless communication capable of transmitting and/or receiving data through multiple links, the WLAN FW 607 may identify whether the external electronic device 320 supports short-range wireless communication capable of transmitting and/or receiving data through multiple links.

In an embodiment, when it is identified that the external electronic device 320 supports short-range wireless communication capable of transmitting and/or receiving data through multiple links, the WLAN FW 607 may select at least one link among the multiple links as a link to be used for transmitting and/or receiving data.

As part of the operation of establishing a link, the WLAN FW 607 may determine characteristics of the selected link, based on capability information of the external electronic device 320. Determining the characteristics of the selected link may be performed after selecting a link to be activated or during the procedure of selecting a link to be activated. According to an example, the characteristics of the link may include the size of the bandwidth of the link, the MCS level of data to be transmitted or received through the link, and/or the number of spatial streams.

According to an example, WLAN FW 607 may identify the information related to the selected link and included in the capability information of the external electronic device 320 (e.g., identification information of APs supporting each of the multiple links, bandwidth information of each of the multiple links, the MCS level of data to be transmitted or received through the multiple links, and the number of spatial streams (N_{SS}) of each of the multiple links), and may determine the characteristics of the link by considering the capability that the electronic device 310 can support.

In operation 612, the WLAN FW 607 may select (or determine) an operating mode of the interface 313, based on the maximum data rate of the multiple links generated between the electronic device 310 and the external electronic device 320.

The WLAN FW 607 may identify the maximum data rate of multiple links and select, based on the maximum data rate, an operating mode in which the interface 313 is to operate.

The WLAN FW 607 may identify the maximum data rate of data to be transmitted or received through multiple links activated between the electronic device 310 and the external electronic device 320, and select, based on the maximum data rate, an operating mode in which the interface 413 is to operate.

The WLAN FW 607 may identify the maximum data rate of the data to be transmitted or received through each of the multiple links in order to identify the maximum data rate of the data to be transmitted or received through the multiple links activated between the electronic device 310 and the external electronic device 320.

The WLAN FW 607 may identify the maximum data rate of data to be transmitted or received through each of the multiple links, based on the characteristics of the selected link. The WLAN FW 607 may identify the maximum data rate of data to be transmitted or received through each of the multiple links by referring to mapping data in which the link characteristics and maximum data rate are mapped.

The WLAN FW 607 may identify the maximum data rate of each of the multiple links to be activated between the electronic device 310 and the external electronic device 320, and identify the maximum data rate of the multiple links, based on the operating mode for short-range wireless communication. The maximum data rate of the multiple links may mean the maximum data rate of data transmitted by the electronic device 310 to the external electronic device 320.

The operating mode for short-range wireless communication may include a mode (e.g., multi-link operation (MLO)) of transmitting or receiving data through multiple links. A mode of transmitting or receiving data through multiple links may include a mode in which simultaneous data transmission through multiple links is possible (e.g., multi-link multi-radio (MLMR), enhanced multi-link multi-radio (EMLMR)) and a mode in which data transmission through one of multiple links is possible (e.g., multi-link single-radio (MLSR), enhanced multi-link single-radio (EMLSR)). When the electronic device 310 operates in a mode in which simultaneous data transmission is possible through multiple links, the electronic device 310 may transmit data through one link while data transmission through another link is performed. When the electronic device 310 operates in a mode in which data transmission is possible through one of multiple links, the electronic device 310 may not be able to transmit data through another link while data transmission through one link is performed.

In an embodiment, when the electronic device 310 operates in a mode in which data transmission through multiple links is possible, the WLAN FW 607 may determine, as the maximum data rate of multiple links, the sum of the maximum data rates of each of the multiple links generated between the electronic device 310 and the external electronic device 320. A mode in which the electronic device 310 is capable of simultaneously transmitting data through multiple links is a mode in which simultaneous data transmission through multiple links is possible, and in which the sum of the maximum data rates of each of the multiple links may be the maximum data rate of the multiple links.

According to an example, the WLAN FW 607 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through multiple links is possible, the WLAN FW 607 may determine, as the maximum data rate (e.g., 2179.5 Mbps) of multiple links, the sum of the maximum data rates (e.g., 1147.1 Mbps+1032.4 Mbps) of each of the multiple links generated between the electronic device 310 and the external electronic device 320.

When the electronic device 310 operates in a mode in which data transmission through one of multiple links is possible, the WLAN FW 607 may determine, as the maximum data rate of the multiple links, the largest data rate among the maximum data rates of each of the multiple links generated between the electronic device 310 and the external electronic device 320.

A mode in which the electronic device 310 is capable of transmitting data through one of multiple links is a mode in which while data transmission through one of multiple links is performed, data transmission through another link is impossible, and in which the largest value among the maximum data rates of each of the multiple links may be the maximum data rate of multiple links.

According to another example, the WLAN FW 607 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through one of multiple links is possible, the WLAN FW 607 may determine, as the maximum data rate (e.g., 1147.1 Mbps) of multiple links, the largest value (e.g., the maximum data rate 1147.1 Mbps of the first link 331) among the maximum data rates of each of the multiple links (e.g., the maximum data rate 1147.1 Mbps of the first link 331 and the maximum data rate 1032.4 Mbps of the second link 332) generated between the electronic device 310 and the external electronic device 320.

The WLAN FW 607 may select an operating mode that supports a data rate higher than the maximum data rate, as the operating mode in which the interface 313 is to operate. For example, the processor 510 may select one of operating modes (e.g., a second operating mode, a third operating mode, a fourth operating mode, and/or a fifth operating mode) that supports a data rate higher than the maximum data rate (e.g., 3.5 Gbps) included in the determined configuration, as the operating mode in which the interface 313 is to operate. The WLAN FW 607 may select an operating mode (e.g., a second operating mode) having the lowest maximum data rate among operating modes that support a data rate higher than the maximum data rate included in the determined configuration, as the operating mode in which the interface 313 is to operate.

The WLAN FW 607 may transmit an operating mode change request message of the interface to the PCIe EP driver 605 in operation 613.

The operating mode change request message of the interface may include information indicating the selected operating mode.

The PCIe EP driver 605 may transmit the operating mode change request message of the interface to the PCIe RC driver 603 in operation 614.

The operating mode change request message of the interface may include information indicating the selected operating mode and may be a message requesting a transition to the selected operating mode.

The PCIe RC driver 603 may activate the selected operating mode in operation 615.

The PCIe RC driver 603 may activate the operating mode of the interface implemented on the application processor 411. The operating mode of the interface implemented on the processor 510 may be configured by the PCIe EP driver 605.

In operation 616, the PCIe RC driver 603 may, in response to completion of activation of the selected operating mode, transmit a confirmation message indicating that the selected operating mode is activated to the PCIe EP driver 605.

In operation 617, the PCIe EP driver 605 may activate the selected operating mode in response to receiving the confirmation message.

In operation 618, the PCIe EP driver 605 may, in response to the selected operating mode being activated, transmit a response message indicating that the selected operating mode is activated to the WLAN FW 607.

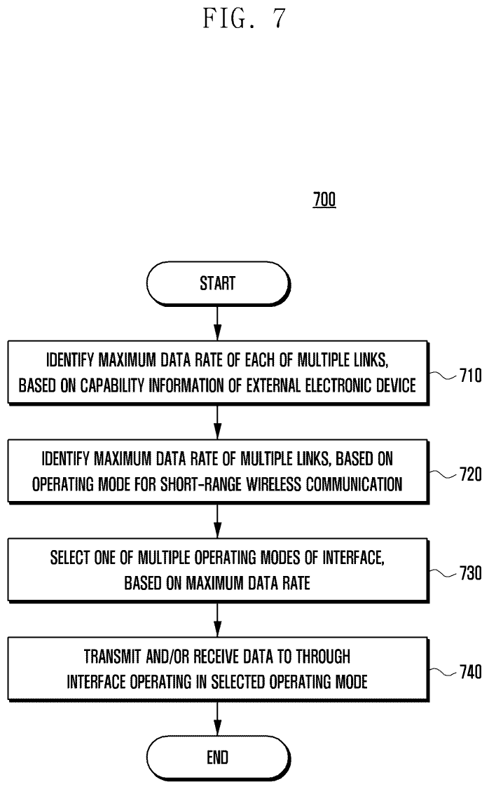

FIG. 7 is an operation flowchart 700 illustrating a method of operating an electronic device according to an embodiment of the disclosure.

In operation 710, the electronic device (e.g., the electronic device 310 of FIG. 5) may identify the maximum data of each of the multiple links, based on capability information of the external electronic device (e.g., the external electronic device 320 of FIG. 4).

According to various embodiments of the disclosure, the electronic device 310 may receive capability information of the external electronic device 320, as part of an operation of establishing a channel for exchanging data with the external electronic device 320. The electronic device 310 may transmit, to the external electronic device 320, a channel generation request message related to short-range wireless communication (e.g., a beacon message or a probe response message, which is a response message corresponding to a probe message transmitted by the external electronic device 320). The external electronic device 320 may receive the channel generation request message from the electronic device 310 and transmit a response message including capability information of the external electronic device 320 to the electronic device 310.

The capability information of the external electronic device 320 may be capability information related to short-range wireless communication supported by the external electronic device 320.

In an example, the capability information of the external electronic device 320 may include information regarding the generation of short-range wireless communication (e.g., Wi-Fi 4, Wi-Fi 5, Wi-Fi 6, Wi-Fi6e, and/or Wi-Fi 7) supported by the external electronic device 320, channel bandwidth information, information indicating the maximum data rate, and/or information indicating the modulation and coding scheme (MCS).

For example, the capability information of the external electronic device 320 may include information indicating whether the external electronic device 320 supports short-range wireless communication capable of transmitting and/or receiving data through multiple links.

In another example, when the external electronic device 320 supports short-range wireless communication capable of transmitting and/or receiving data through multiple links, the capability information of the external electronic device 320 may include information related to multiple links (e.g., identification information of APs supporting each of multiple links, bandwidth information of each of the multiple links, MCS level of data to be transmitted or received through the multiple links, and/or the number of spatial streams (NSS) of each of the multiple links). When the external electronic device 320 supports enhanced multi-link multi-radio (EMLMR) or enhanced multi-link single-radio (EMLSR), the number of spatial streams for each of the multiple links may be included in a frame (e.g., an EML operating mode notification frame) that indicates support for the EMLMR or EMLSR mode defined in the EMLMR or EMLSR.

The electronic device 310 may receive capability information of the external electronic device 320 and establish a link to be connected to the external electronic device 320, based on the capability information of the external electronic device 320.

The electronic device 310 may, based on the capability information of the external electronic device 320, identify whether the external electronic device 320 supports short-range wireless communication capable of transmitting and/or receiving data through multiple links. Based on the information included in the capability information of the external electronic device 320 and indicating whether the external electronic device 320 supports short-range wireless communication capable of transmitting and/or receiving data through multiple links, the electronic device 310 may identify whether the external electronic device 320 supports short-range wireless communication capable of transmitting and/or receiving data through multiple links.

When it is identified that the external electronic device 320 supports short-range wireless communication capable of transmitting and/or receiving data through multiple links, the electronic device 310 may select at least one link among the multiple links as a link to be used for transmitting and/or receiving data.

As part of the operation of establishing a link, the electronic device 310 may, for example, determine characteristics of the selected link, based on capability information of the external electronic device 320. Determining the characteristics of the selected link may be performed after selecting a link to be activated or during the procedure of selecting a link to be activated. According to an example, the characteristics of the link may include the size of the bandwidth of the link, the MCS level of data to be transmitted or received through the link, and/or the number of spatial streams.

According to an example, the electronic device 310 may identify the information related to the selected link and included in the capability information of the external electronic device 320 (e.g., identification information of APs supporting each of the multiple links, bandwidth information of each of the multiple links, the MCS level of data to be transmitted or received through the multiple links, and the number of spatial streams (N_{SS}) of each of the multiple links), and may determine the characteristics of the link by considering the capability that the electronic device 310 can support.

The electronic device 310 may, for example, select at least one of multiple links, determine characteristics of the selected link, and transmit a signal (e.g., an association request frame) including information indicating the selected link and information related to the selected link to the external electronic device 320. The association request frame may be a signal requesting activation of the selected link. Information related to the selected link may include characteristics of the selected link.

The external electronic device 320 may receive the association request frame transmitted by the electronic device 310 and identify the link selected by the electronic device 310 and included in the association request frame. The external electronic device 320 may determine whether the link selected by the electronic device 310 is activated and transmit an association response frame including information indicating whether each selected link is activated to the electronic device 310.

The electronic device 310 may receive the association response frame transmitted by the external electronic device 320 and identify the information included in the association response frame and indicating whether each selected link is activated. The electronic device 310 may activate at least one link, based on the information indicating whether each selected link is activated.

According to an example, the electronic device 310 may receive a configuration to be used by the external electronic device 320 for short-range wireless communication determined based on the capability information of the electronic device 310 and the capability information of the external electronic device 320. When the processor 510 receives a configuration to be used for short-range wireless communication determined by the external electronic device 320, the procedure of selecting a link and/or determining the characteristics of the link by the processor 510 may be omitted.

The electronic device 310 may control the interface 413 to perform short-range wireless communication. The electronic device 310 may, for example, identify the maximum data rate of data to be transmitted or received through multiple links activated between the electronic device 310 and the external electronic device 320, and select, based on the maximum data rate, an operating mode in which the interface 413 is to operate.

The electronic device 310 may identify the maximum data rate of the data to be transmitted or received through each of the multiple links in order to identify the maximum data rate of the data to be transmitted or received through the multiple links activated between the electronic device and the external electronic device 320.

The electronic device 310 may, based on the characteristics of the selected link, identify the maximum data rate of data to be transmitted or received through each of the multiple links. The electronic device 310 may identify the maximum data rate of data to be transmitted or received through each of the multiple links by referring to mapping data in which the link characteristics and maximum data rate are mapped.

According to an example, a first link (e.g., the first link 331 of FIG. 3A) and a second link (e.g., the second link 332 of FIG. 3A) are activated between the electronic device 310 and the external electronic device 320, and when the processor 510 determines the MCS level of the data to be transmitted or received through the first link 331 as 11, the data to be transmitted or received through the first link 331 may have a maximum data rate of 1147.1 Mbps.

According to an example, a first link (e.g., first link 331 of FIG. 3A) and a second link (e.g., second link 332 of FIG. 3A) are activated between the electronic device 310 and the external electronic device 320, and when the processor 510 determines the MCS level of the data to be transmitted or received through the second link 332 as 10, the data to be transmitted or received through the second link 332 may have a maximum data rate of 1032.4 Mbps.

In operation 720, the electronic device 310 may identify the maximum data rates of multiple links, based on the operating mode for the short-range wireless communication.

The electronic device 310 may identify the maximum data rate of each of the multiple links to be activated between the electronic device 310 and the external electronic device 320, and identify the maximum data rate of the multiple links, based on the operating mode for short-range wireless communication. The maximum data rate of the multiple links may mean the maximum data rate of data transmitted by the electronic device 310 to the external electronic device 320.

The operating mode for short-range wireless communication may include a mode (e.g., multi-link operation (MLO)) of transmitting or receiving data through multiple links. A mode (e.g., multi-link operation (MLO)) of transmitting or receiving data through multiple links may include a mode in which simultaneous data transmission through multiple links is possible (e.g., multi-link multi-radio (MLMR), enhanced multi-link multi-radio (EMLMR)) and a mode in which data transmission through one of multiple links is possible (e.g., multi-link single-radio (MLSR), enhanced multi-link single-radio (EMLSR)). When the electronic device 310 operates in a mode in which simultaneous data transmission is possible through multiple links, the electronic device 310 may transmit data through one link while data transmission through another link is performed. When the electronic device 310 operates in a mode in which data transmission is possible through one of multiple links, the electronic device 310 may not be able to transmit data through another link while data transmission through one link is performed.

When the electronic device 310 operates in a mode in which data transmission through multiple links is possible, the electronic device 310 may determine, as the maximum data rate of multiple links, the sum of the maximum data rates of each of the multiple links generated between the electronic device 310 and the external electronic device 320. A mode in which the electronic device 310 is capable of simultaneously transmitting data through multiple links is a mode in which simultaneous data transmission through multiple links is possible, and in which the sum of the maximum data rates of each of the multiple links may be the maximum data rate of the multiple links.

The electronic device 310 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through multiple links is possible, the electronic device 310 may determine, as the maximum data rate (e.g., 2179.5 Mbps) of multiple links, the sum of the maximum data rates (e.g., 1147.1 Mbps+1032.4 Mbps) of each of the multiple links generated between the electronic device 310 and the external electronic device 320.

When the electronic device 310 operates in a mode in which data transmission through one of multiple links is possible, the electronic device 310 may determine, as the maximum data rate of the multiple links, the largest data rate among the maximum data rates of each of the multiple links generated between the electronic device 310 and the external electronic device 320.

A mode in which the electronic device 310 is capable of transmitting data through one of multiple links is a mode in which while data transmission through one of multiple links is performed, data transmission through another link is impossible, and in which the largest value among the maximum data rates of each of the multiple links may be the maximum data rate of multiple links.

According to an example, the electronic device 310 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through one of multiple links is possible, the electronic device 310 may determine, as the maximum data rate (e.g., 1147.1 Mbps) of multiple links, the largest value (e.g., the maximum data rate 1147.1 Mbps of the first link 331) among the maximum data rates of each of the multiple links (e.g., the maximum data rate 1147.1 Mbps of the first link 331 and the maximum data rate 1032.4 Mbps of the second link 332) generated between the electronic device 310 and the external electronic device 320.

In operation 730, the electronic device 310 may, based on the maximum data rate, select one of multiple operating modes of the interface (e.g., the interface 413 of FIG. 5).

The electronic device 310 may determine the maximum data rate of the multiple links, based on the operating mode for short-range wireless communication, and may select one of the multiple operating modes of the interface 413, based on the maximum data rate of the multiple links.

According to an embodiment, the electronic device 310 may select an operating mode that supports a data rate higher than the maximum data rate, as the operating mode in which the interface 413 is to operate. For example, the electronic device 310 may select one of operating modes (e.g., a second operating mode, a third operating mode, a fourth operating mode, and/or a fifth operating mode) that supports a data rate higher than the maximum data rate (e.g., 2179.5 Mbps) of the multiple links, as the operating mode in which the interface 413 is to operate. According to an embodiment, the electronic device 310 may select an operating mode (e.g., a second operating mode) having the lowest maximum data rate among operating modes that support a data rate higher than the maximum data rate of multiple links, as the operating mode in which the interface 413 is to operate, thereby preventing bottlenecks and reducing power consumption.

In response to identifying that the interface 413 is operating in an operating mode different from the selected operating mode, the electronic device 310 may control the interface 413 to operate in the selected operating mode. The electronic device 310 may control the interface 413 to transition the state of the interface 413 from an active state (e.g., LO, L0s, or L1) to a recovery state, and to change the operating mode in the recovery state. The recovery state may be a temporarily transitioned state to change the operating mode of the interface 413. The electronic device 310 may change the operating mode of the interface 413 after the authentication operation between the external electronic device 320 and the electronic device 310 has been completed during the operation of activating multiple links between the external electronic device 320 and the electronic device 310, after receiving an association response frame, or during the generation and/or transmission of an association request frame. In response to the completion of the transition of the operating mode of the interface 413, the electronic device 310 may perform various operations for establishing a channel (e.g., an association operation between an external electronic device 320 and the electronic device 310) and complete the activation operation of multiple links.

In operation 740, the electronic device 310 may transmit and/or receive data through the interface 413 operating in the selected operating mode.

The processor 510 may receive data, transmitted by the application processor 411, through the interface 413 operating in the selected operating mode and transmit the data to the external electronic device 320. Alternatively, the processor 510 may transmit data, transmitted by the external electronic device 320, to the application processor 411 through the interface 413 operating in the selected operating mode.

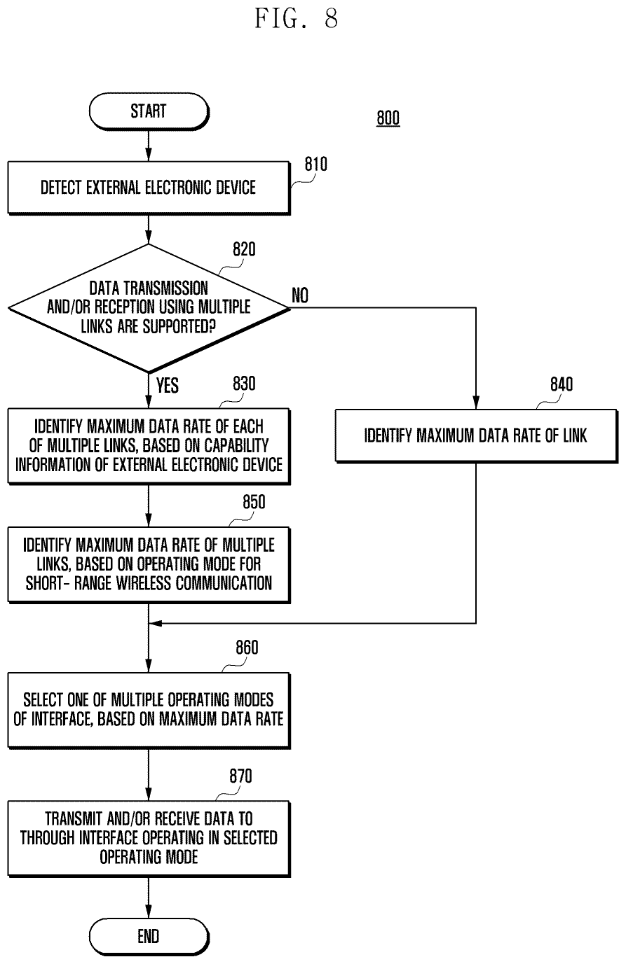

FIG. 8 is an operation flowchart 800 illustrating a method of operating an electronic device according to an embodiment of the disclosure.

The electronic device (e.g., the electronic device 310 of FIG. 5) may detect an external electronic device (e.g., the external electronic device 320 of FIG. 4) in operation 810.

When the electronic device 310 has received a beacon message broadcast by the external electronic device 320, the electronic device 310 may detect the external electronic device 320. Alternatively, the electronic device 310 may broadcast a probe request message to find an external electronic device to be connected to the electronic device 310, and when a probe response message indicating receiving of the probe request message is received, the electronic device 310 may detect the external electronic device 320.

According to some embodiments of the disclosure, the electronic device 310 may receive capability information of the external electronic device 320, as part of an operation of establishing a channel for exchanging data with the external electronic device 320. The electronic device 310 may transmit, to the external electronic device 320, a channel generation request message related to short-range wireless communication (e.g., a beacon message or a probe response message, which is a response message corresponding to a probe message transmitted by the external electronic device 320). The external electronic device 320 may receive the channel generation request message from the electronic device 310 and transmit a response message including capability information of the external electronic device 320 to the electronic device 310.

The capability information of the external electronic device 320 may be capability information related to short-range wireless communication supported by the external electronic device 320.

For example, the capability information of the external electronic device 320 may include information regarding the generation of short-range wireless communication (e.g., Wi-Fi 4, Wi-Fi 5, Wi-Fi 6, Wi-Fi6e, and/or Wi-Fi 7) supported by the external electronic device 320, channel bandwidth information, information indicating the maximum data rate, and/or information indicating the modulation and coding scheme (MCS).

For example, the capability information of the external electronic device 320 may include information indicating whether the external electronic device 320 supports short-range wireless communication capable of transmitting and/or receiving data through multiple links.

When the external electronic device 320 supports short-range wireless communication capable of transmitting and/or receiving data through multiple links, the capability information of the external electronic device 320 may include information related to multiple links (e.g., identification information of APs supporting each of multiple links, bandwidth information of each of the multiple links, MCS level of data to be transmitted or received through the multiple links, and/or the number of spatial streams (NSS) of each of the multiple links). When the external electronic device 320 supports enhanced multi-link multi-radio (EMLMR) or enhanced multi-link single-radio (EMLSR), the number of spatial streams for each of the multiple links may be included in a frame (e.g., an EML operating mode notification frame) that indicates support for the EMLMR or EMLSR mode defined in the EMLMR or EMLSR.

In operation 820, the electronic device 310 may identify whether the external electronic device 320 supports transmission and/or reception of data using multiple links.

The electronic device 310 may, based on the capability information of the external electronic device 320, identify whether the external electronic device 320 supports short-range wireless communication capable of transmitting and/or receiving data through multiple links. Based on the information included in the capability information of the external electronic device 320 and indicating whether the external electronic device 320 supports short-range wireless communication capable of transmitting and/or receiving data through multiple links, the electronic device 310 may identify whether the external electronic device 320 supports short-range wireless communication capable of transmitting and/or receiving data through multiple links.

When it is identified that the external electronic device 320 supports short-range wireless communication capable of transmitting and/or receiving data through multiple links, the electronic device 310 may select at least one link among the multiple links as a link to be used for transmitting and/or receiving data.

Based on identifying that the external electronic device 320 supports data transmission and/or reception using the multiple links (“Y” in operation 820), the electronic device 310 may identify the maximum data rate for each of the multiple links, based on capability information of the external electronic device 320, in operation 830.

When it is identified that the external electronic device 320 supports short-range wireless communication capable of transmitting and/or receiving data through multiple links, the electronic device 310 may select at least one link among the multiple links as a link to be used for transmitting and/or receiving data.

As part of the operation of establishing a link, the electronic device 310 may determine characteristics of the selected link, based on capability information of the external electronic device 320. Determining the characteristics of the selected link may be performed after selecting a link to be activated or during the procedure of selecting a link to be activated. According to an example, the characteristics of the link may include the size of the bandwidth of the link, the MCS level of data to be transmitted or received through the link, and/or the number of spatial streams.

According to an example, the electronic device 310 may identify the information related to the selected link and included in the capability information of the external electronic device 320 (e.g., identification information of APs supporting each of the multiple links, bandwidth information of each of the multiple links, the MCS level of data to be transmitted or received through the multiple links, and the number of spatial streams (N_{SS}) of each of the multiple links), and may determine the characteristics of the link by considering the capability that the electronic device 310 can support.

The electronic device 310 may select at least one of multiple links, determine characteristics of the selected link, and transmit a signal (e.g., an association request frame) including information indicating the selected link and information related to the selected link to the external electronic device 320. The association request frame may be a signal requesting activation of the selected link. Information related to the selected link may include characteristics of the selected link.

In an embodiment, the external electronic device 320 may receive the association request frame transmitted by the electronic device 310 and identify the link selected by the electronic device 310 and included in the association request frame. The external electronic device 320 may determine whether the link selected by the electronic device 310 is active and transmit an association response frame including information indicating whether each selected link is active to the electronic device 310.

The electronic device 310 may receive the association response frame transmitted by the external electronic device 320 and identify the information included in the association response frame and indicating whether each selected link is active. The electronic device 310 may activate at least one link, based on the information indicating whether each selected link is active.

According to an example, the electronic device 310 may receive a configuration to be used by the external electronic device 320 for short-range wireless communication determined based on the capability information of the electronic device 310 and the capability information of the external electronic device 320. When the processor 510 receives a configuration to be used for short-range wireless communication determined by the external electronic device 320, the procedure of selecting a link and/or determining the characteristics of the link by the processor 510 may be omitted.

In another embodiment, the electronic device 310 may control the interface 413 to perform short-range wireless communication. The electronic device 310 may identify the maximum data rate of data to be transmitted or received through multiple links activated between the electronic device 310 and the external electronic device 320, and select, based on the maximum data rate, an operating mode in which the interface 413 is to operate.

Based on identifying that the external electronic device 320 does not support data transmission and/or reception using the multiple links (“N” in operation 820), the electronic device 310 may identify the maximum data rate for one link, based on capability information of the external electronic device 320, in operation 840.

In operation 850, the electronic device 310 may identify the maximum data rate of multiple links, based on the operating mode for short-range wireless communication.

The electronic device 310 may identify the maximum data rate of each of the multiple links to be activated between the electronic device 310 and the external electronic device 320, and identify the maximum data rate of the multiple links, based on the operating mode for short-range wireless communication. The maximum data rate of the multiple links may mean the maximum data rate of data transmitted by the electronic device 310 to the external electronic device 320.

The operating mode for short-range wireless communication may include a mode (e.g., multi-link operation (MLO)) of transmitting or receiving data through multiple links. A mode (e.g., multi-link operation (MLO)) of transmitting or receiving data through multiple links may include a mode in which simultaneous data transmission through multiple links is possible (e.g., multi-link multi-radio (MLMR), enhanced multi-link multi-radio (EMLMR)) and a mode in which data transmission through one of multiple links is possible (e.g., multi-link single-radio (MLSR), enhanced multi-link single-radio (EMLSR)). When the electronic device 310 operates in a mode in which simultaneous data transmission is possible through multiple links, the electronic device 310 may transmit data through one link while data transmission through another link is performed. When the electronic device 310 operates in a mode in which data transmission is possible through one of multiple links, the electronic device 310 may not be able to transmit data through another link while data transmission through one link is performed.

When the electronic device 310 operates in a mode in which data transmission through multiple links is possible, the electronic device 310 may determine, as the maximum data rate of multiple links, the sum of the maximum data rates of each of the multiple links generated between the electronic device 310 and the external electronic device 320. A mode in which the electronic device 310 is capable of simultaneously transmitting data through multiple links is a mode in which simultaneous data transmission through multiple links is possible, and in which the sum of the maximum data rates of each of the multiple links may be the maximum data rate of the multiple links.

In an embodiment, the electronic device 310 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through multiple links is possible, the electronic device 310 may determine, as the maximum data rate (e.g., 2179.5 Mbps) of multiple links, the sum of the maximum data rates (e.g., 1147.1 Mbps+1032.4 Mbps) of each of the multiple links generated between the electronic device 310 and the external electronic device 320.

When the electronic device 310 operates in a mode in which data transmission through one of multiple links is possible, the electronic device 310 may determine, as the maximum data rate of the multiple links, the largest data rate among the maximum data rates of each of the multiple links generated between the electronic device 310 and the external electronic device 320.

A mode in which the electronic device 310 is capable of transmitting data through one of multiple links is a mode in which while data transmission through one of multiple links is performed, data transmission through another link is impossible. The largest value among the maximum data rates of each of the multiple links may be the maximum data rate of multiple links.

In another embodiment, the electronic device 310 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through one of multiple links is possible, the electronic device 310 may determine, as the maximum data rate (e.g., 1147.1 Mbps) of multiple links, the largest value (e.g., the maximum data rate 1147.1 Mbps of the first link 331) among the maximum data rates of each of the multiple links (e.g., the maximum data rate 1147.1 Mbps of the first link 331 and the maximum data rate 1032.4 Mbps of the second link 332) generated between the electronic device 310 and the external electronic device 320.

In operation 860, the electronic device 310 may, based on a maximum data rate, select one of multiple operating modes of the interface (e.g., the interface 413 of FIG. 5).

The electronic device 310 may determine the maximum data rate of the multiple links, based on the operating mode for short-range wireless communication, and may select one of the multiple operating modes of the interface 413, based on the maximum data rate of the multiple links.

According to an embodiment, the electronic device 310 may select an operating mode that supports a data rate higher than the maximum data rate, as the operating mode in which the interface 413 is to operate. For example, the electronic device 310 may select one of operating modes (e.g., a second operating mode, a third operating mode, a fourth operating mode, and/or a fifth operating mode) that supports a data rate higher than the maximum data rate (e.g., 2179.5 Mbps) of the multiple links, as the operating mode in which the interface 413 is to operate. According to an embodiment, the electronic device 310 may select an operating mode (e.g., a second operating mode) having the lowest maximum data rate among operating modes that support a data rate higher than the maximum data rate of multiple links, as the operating mode in which the interface 413 is to operate, thereby preventing bottlenecks and reducing power consumption.

According to an example, the electronic device 310 may select a third operating mode (e.g., PCIe 2.0) when the maximum data rate of multiple links is equal to or greater than a designated value (e.g., 4 Gbps). The electronic device 310 may select a second operating mode (e.g., PCIe 2.0) when the maximum data rate of the multiple links is less than or equal to (or less than) a designated value (e.g., 4 Gbps).

When the external electronic device 320 does not support data transmission and/or reception using multiple links (“N” in operation 820), the electronic device 310 may identify the maximum data rate of a single link between the external electronic device 320 and the electronic device 310. The maximum data rate of a single link between the external electronic device 320 and the electronic device 310 may be, for example, determined based on capability information of the external electronic device 320. According to an example, the electronic device 310 may identify the maximum data rate, based on the characteristics (e.g., MCS level, number of spatial streams) of the link between the electronic device 310 and the external electronic device 320 and mapping data. The electronic device 310 may, based on the maximum data rate, select one of the multiple operating modes of the interface 413.

Alternatively, the external electronic device 320 does not support data transmission and/or reception using multiple links (“N” in operation 820), the electronic device 310 may select one of the multiple operating modes of the interface 413, based on the maximum bandwidth of a single link between the external electronic device 320 and the electronic device 310.

According to an example, in case that the maximum bandwidth of a single link between the external electronic device 320 and the electronic device 310 is greater than or equal to (or greater than) a designated value (e.g., 320 MHZ) (or, in case that a single link between the external electronic device 320 and the electronic device 310 supports the maximum bandwidth defined in Wi-Fi 7), the electronic device 310 may select a third operating mode (e.g., PCIe 3.0). In case that the maximum bandwidth of a single link between the external electronic device 320 and the electronic device 310 is equal to or less than (or less than) a designated value (e.g., 320 MHZ) (or, in case that a single link between the external electronic device 320 and the electronic device 310 does not support the maximum bandwidth defined in Wi-Fi 7), the electronic device 310 may select a second mode of operation (e.g. PCIe 2.0).

In response to identifying that the interface 413 is operating in an operating mode different from the selected operating mode, the electronic device 310 may control the interface 413 to operate in the selected operating mode. The electronic device 310 may control the interface 413 to transition the state of interface 413 from an active state (e.g., LO, L0s, or L1) to a recovery state, and to change the operating mode in the recovery state. The recovery state may be a temporarily transitioned state to change the operating mode of the interface 413. The electronic device 310 may, for example, change the operating mode of the interface 413 after the authentication operation between the external electronic device 320 and the electronic device 310 has been completed during the operation of activating multiple links between the external electronic device 320 and the electronic device 310, after receiving the association response frame, or during the generation and/or transmission of the association request frame. In response to the completion of the transition of the operating mode of the interface 413, the electronic device 310 may perform various operations for establishing a channel (e.g., an association operation between an external electronic device 320 and the electronic device 310) and complete the activation operation of multiple links.

In operation 870, the electronic device 310 may transmit and/or receive data through the interface 413 operating in the selected operating mode.

The processor 510 may receive data, transmitted by the application processor 411, through the interface 413 operating in the selected operating mode and transmit the data to the external electronic device 320. Alternatively, the processor 510 may transmit data, transmitted by the external electronic device 320, to the application processor 411 through the interface 413 operating in the selected operating mode.

FIG. 8 is an operation flowchart 800 illustrating a method of operating an electronic device according to various embodiments of the disclosure.

The electronic device (e.g., the electronic device 310 of FIG. 5) may detect an external electronic device (e.g., the external electronic device 320 of FIG. 4) in operation 810.

When the electronic device 310 has received a beacon message broadcast by the external electronic device 320, the electronic device 310 may detect the external electronic device 320. Alternatively, the electronic device 310 may broadcast a probe request message to find an external electronic device to be connected to the electronic device 310, and when a probe response message indicating receiving of the probe request message is received, the electronic device 310 may detect the external electronic device 320.

According to various embodiments of the disclosure, the electronic device 310 may receive capability information of the external electronic device 320, as part of an operation of establishing a channel for exchanging data with the external electronic device 320. The electronic device 310 may transmit, to the external electronic device 320, a channel generation request message related to short-range wireless communication (e.g., a beacon message or a probe response message, which is a response message corresponding to a probe message transmitted by the external electronic device 320). The external electronic device 320 may receive the channel generation request message from the electronic device 310 and transmit a response message including capability information of the external electronic device 320 to the electronic device 310.

The capability information of the external electronic device 320 may be capability information related to short-range wireless communication supported by the external electronic device 320.

For example, the capability information of the external electronic device 320 may include information regarding the generation of short-range wireless communication (e.g., Wi-Fi 4, Wi-Fi 5, Wi-Fi 6, Wi-Fi6e, and/or Wi-Fi 7) supported by the external electronic device 320, channel bandwidth information, information indicating the maximum data rate, and/or information indicating the modulation and coding scheme (MCS).

For example, the capability information of the external electronic device 320 may include information indicating whether the external electronic device 320 supports short-range wireless communication capable of transmitting and/or receiving data through multiple links.

When the external electronic device 320 supports short-range wireless communication capable of transmitting and/or receiving data through multiple links, the capability information of the external electronic device 320 may include information related to multiple links (e.g., identification information of APs supporting each of multiple links, bandwidth information of each of the multiple links, MCS level of data to be transmitted or received through the multiple links, and/or the number of spatial streams (NSS) of each of the multiple links). When the external electronic device 320 supports enhanced multi-link multi-radio (EMLMR) or enhanced multi-link single-radio (EMLSR), the number of spatial streams for each of the multiple links may be included in a frame (e.g., an EML operating mode notification frame) that indicates support for the EMLMR or EMLSR mode defined in the EMLMR or EMLSR.

In operation 820, the electronic device 310 may identify whether the external electronic device 320 supports transmission and/or reception of data using multiple links.

The electronic device 310 may, based on the capability information of the external electronic device 320, identify whether the external electronic device 320 data through multiple links. Based on the information included in the capability information of the external electronic device 320 and indicating whether the external electronic device 320 supports short-range wireless communication capable of transmitting and/or receiving data through multiple links, the electronic device 310 may identify whether the external electronic device 320 supports short-range wireless communication capable of transmitting and/or receiving data through multiple links.

When it is identified that the external electronic device 320 supports short-range wireless communication capable of transmitting and/or receiving data through multiple links, the electronic device 310 may select at least one link among the multiple links as a link to be used for transmitting and/or receiving data.

Based on identifying that the external electronic device 320 supports data transmission and/or reception using the multiple links (“Y” in operation 820), the electronic device 310 may identify the maximum data rate for each of the multiple links, based on capability information of the external electronic device 320, in operation 830.

In an embodiment, when it is identified that the external electronic device 320 supports short-range wireless communication capable of transmitting and/or receiving data through multiple links, the electronic device 310 may select at least one link among the multiple links as a link to be used for transmitting and/or receiving data.

As part of the operation of establishing a link, the electronic device 310 may determine characteristics of the selected link, based on capability information of the external electronic device 320. Determining the characteristics of the selected link may be performed after selecting a link to be activated or during the procedure of selecting a link to be activated. According to an example, the characteristics of the link may include the size of the bandwidth of the link, the MCS level of data to be transmitted or received through the link, and/or the number of spatial streams.

According to an example, the electronic device 310 may identify the information related to the selected link and included in the capability information of the external electronic device 320 (e.g., identification information of APs supporting each of the multiple links, bandwidth information of each of the multiple links, the MCS level of data to be transmitted or received through the multiple links, and the number of spatial streams (N_{SS}) of each of the multiple links), and may determine the characteristics of the link by considering the capability that the electronic device 310 can support.

The electronic device 310 may select at least one of multiple links, determine characteristics of the selected link, and transmit a signal (e.g., an association request frame) including information indicating the selected link and information related to the selected link to the external electronic device 320. The association request frame may be a signal requesting activation of the selected link. Information related to the selected link may include characteristics of the selected link.

The external electronic device 320 may receive the association request frame transmitted by the electronic device 310 and identify the link selected by the electronic device 310 and included in the association request frame. The external electronic device 320 may determine whether the link selected by the electronic device 310 is active and transmit an association response frame including information indicating whether each selected link is active to the electronic device 310.

The electronic device 310 may receive the association response frame transmitted by the external electronic device 320 and identify the information included in the association response frame and indicating whether each selected link is active. The electronic device 310 may activate at least one link, based on the information indicating whether each selected link is active.

The electronic device 310 may receive a configuration to be used by the external electronic device 320 for short-range wireless communication determined based on the capability information of the electronic device 310 and the capability information of the external electronic device 320. When the processor 510 receives a configuration to be used for short-range wireless communication determined by the external electronic device 320, the procedure of selecting a link and/or determining the characteristics of the link by the processor 510 may be omitted.

The electronic device 310 may control the interface 413 to perform short-range wireless communication. The electronic device 310 may identify the maximum data rate of data to be transmitted or received through multiple links activated between the electronic device 310 and the external electronic device 320, and select, based on the maximum data rate, an operating mode in which the interface 413 is to operate.

Based on identifying that the external electronic device 320 does not support data transmission and/or reception using the multiple links (“N” in operation 820), the electronic device 310 may identify the maximum data rate for one link, based on capability information of the external electronic device 320, in operation 840.

In operation 850, the electronic device 310 may identify the maximum data rate of multiple links, based on the operating mode for short-range wireless communication.

The electronic device 310 may, for example, identify the maximum data rate of each of the multiple links to be activated between the electronic device 310 and the external electronic device 320, and identify the maximum data rate of the multiple links, based on the operating mode for short-range wireless communication. The maximum data rate of the multiple links may mean the maximum data rate of data transmitted by the electronic device 310 to the external electronic device 320.

The operating mode for short-range wireless communication may include a mode (e.g., multi-link operation (MLO)) of transmitting or receiving data through multiple links. A mode (e.g., multi-link operation (MLO)) of transmitting or receiving data through multiple links may include a mode in which simultaneous data transmission through multiple links is possible (e.g., multi-link multi-radio (MLMR), enhanced multi-link multi-radio (EMLMR)) and a mode in which data transmission through one of multiple links is possible (e.g., multi-link single-radio (MLSR), enhanced multi-link single-radio (EMLSR)). When the electronic device 310 operates in a mode in which simultaneous data transmission is possible through multiple links, the electronic device 310 may transmit data through one link while data transmission through another link is performed. When the electronic device 310 operates in a mode in which data transmission is possible through one of multiple links, the electronic device 310 may not be able to transmit data through another link while data transmission through one link is performed.

When the electronic device 310 operates in a mode in which data transmission through multiple links is possible, the electronic device 310 may determine, as the maximum data rate of multiple links, the sum of the maximum data rates of each of the multiple links generated between the electronic device 310 and the external electronic device 320. A mode in which the electronic device 310 is capable of simultaneously transmitting data through multiple links is a mode in which simultaneous data transmission through multiple links is possible, and in which the sum of the maximum data rates of each of the multiple links may be the maximum data rate of the multiple links.

According to an example, the electronic device 310 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through multiple links is possible, the electronic device 310 may determine, as the maximum data rate (e.g., 2179.5 Mbps) of multiple links, the sum of the maximum data rates (e.g., 1147.1 Mbps+1032.4 Mbps) of each of the multiple links generated between the electronic device 310 and the external electronic device 320.

In an embodiment, when the electronic device 310 operates in a mode in which data transmission through one of multiple links is possible, the electronic device 310 may determine, as the maximum data rate of the multiple links, the largest data rate among the maximum data rates of each of the multiple links generated between the electronic device 310 and the external electronic device 320.

A mode in which the electronic device 310 is capable of transmitting data through one of multiple links is a mode in which while data transmission through one of multiple links is performed, data transmission through another link is impossible. The largest value among the maximum data rates of each of the multiple links may be the maximum data rate of multiple links.

According to an example, the electronic device 310 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through one of multiple links is possible, the electronic device 310 may determine, as the maximum data rate (e.g., 1147.1 Mbps) of multiple links, the largest value (e.g., the maximum data rate 1147.1 Mbps of the first link 331) among the maximum data rates of each of the multiple links (e.g., the maximum data rate 1147.1 Mbps of the first link 331 and the maximum data rate 1032.4 Mbps of the second link 332) generated between the electronic device 310 and the external electronic device 320.

In operation 860, the electronic device 310 may, based on a maximum data rate, select one of multiple operating modes of the interface (e.g., the interface 413 of FIG. 5).

The electronic device 310 may determine the maximum data rate of the multiple links, based on the operating mode for short-range wireless communication, and may select one of the multiple operating modes of the interface 413, based on the maximum data rate of the multiple links.

According to one embodiment, the electronic device 310 may select an operating mode that supports a data rate higher than the maximum data rate, as the operating mode in which the interface 413 is to operate. For example, the electronic device 310 may select one of operating modes (e.g., a second operating mode, a third operating mode, a fourth operating mode, and/or a fifth operating mode) that supports a data rate higher than the maximum data rate (e.g., 2179.5 Mbps) of the multiple links, as the operating mode in which the interface 413 is to operate. According to an embodiment, the electronic device 310 may select an operating mode (e.g., a second operating mode) having the lowest maximum data rate among operating modes that support a data rate higher than the maximum data rate of multiple links, as the operating mode in which the interface 413 is to operate, thereby preventing bottlenecks and reducing power consumption.

According to an example, the electronic device 310 may select a third operating mode (e.g., PCIe 2.0) when the maximum data rate of multiple links is equal to or greater than a designated value (e.g., 4 Gbps). The electronic device 310 may select a second operating mode (e.g., PCIe 2.0) when the maximum data rate of the multiple links is less than or equal to (or less than) a designated value (e.g., 4 Gbps).

When the external electronic device 320 does not support data transmission and/or reception using multiple links (“N” in operation 820), the electronic device 310 may identify the maximum data rate of a single link between the external electronic device 320 and the electronic device 310. The maximum data rate of a single link between the external electronic device 320 and the electronic device 310 may be determined based on capability information of the external electronic device 320. According to an example, the electronic device 310 may identify the maximum data rate, based on the characteristics (e.g., MCS level, number of spatial streams) of the link between the electronic device 310 and the external electronic device 320 and mapping data. The electronic device 310 may, based on the maximum data rate, select one of the multiple operating modes of the interface 413.

Alternatively, the external electronic device 320 does not support data transmission and/or reception using multiple links (“N” in operation 820), the electronic device 310 may select one of the multiple operating modes of the interface 413, based on the maximum bandwidth of a single link between the external electronic device 320 and the electronic device 310.

According to an example, in case that the maximum bandwidth of a single link between the external electronic device 320 and the electronic device 310 is greater than or equal to (or greater than) a designated value (e.g., 320 MHZ) (or, in case that a single link between the external electronic device 320 and the electronic device 310 supports the maximum bandwidth defined in Wi-Fi 7), the electronic device 310 may select a third operating mode (e.g., PCIe 3.0). In case that the maximum bandwidth of a single link between the external electronic device 320 and the electronic device 310 is equal to or less than (or less than) a designated value (e.g., 320 MHZ) (or, in case that a single link between the external electronic device 320 and the electronic device 310 does not support the maximum bandwidth defined in Wi-Fi 7), the electronic device 310 may select a second mode of operation (e.g. PCIe 2.0).

In response to identifying that the interface 413 is operating in an operating mode different from the selected operating mode, the electronic device 310 may control the interface 413 to operate in the selected operating mode. The electronic device 310 may control the interface 413 to transition the state of interface 413 from an active state (e.g., LO, L0s, or L1) to a recovery state, and to change the operating mode in the recovery state. The recovery state may be a temporarily transitioned state to change the operating mode of the interface 413. The electronic device 310 may change the operating mode of the interface 413 after the authentication operation between the external electronic device 320 and the electronic device 310 has been completed during the operation of activating multiple links between the external electronic device 320 and the electronic device 310, after receiving the association response frame, or during the generation and/or transmission of the association request frame. In response to the completion of the transition of the operating mode of the interface 413, the electronic device 310 may perform various operations for establishing a channel (e.g., an association operation between an external electronic device 320 and the electronic device 310) and complete the activation operation of multiple links.

In operation 870, the electronic device 310 may transmit and/or receive data through the interface 413 operating in the selected operating mode.

The processor 510 may receive data, transmitted by the application processor 411, through the interface 413 operating in the selected operating mode and transmit the data to the external electronic device 320. Alternatively, the processor 510 may transmit data, transmitted by the external electronic device 320, to the application processor 411 through the interface 413 operating in the selected operating mode.

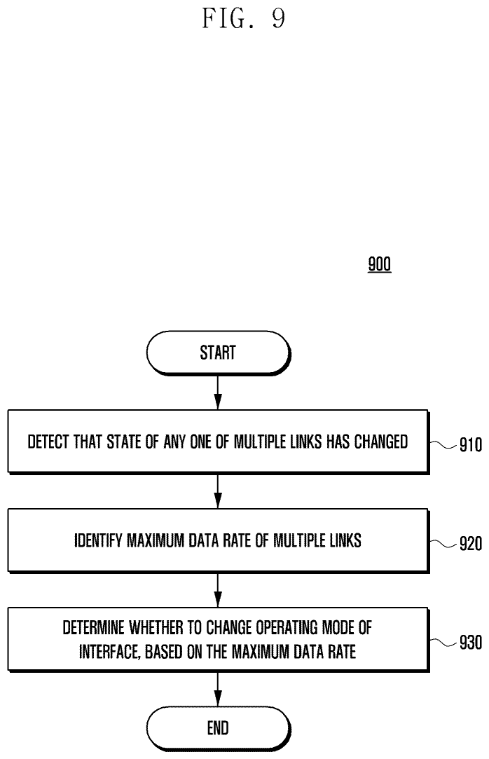

FIG. 9 is an operation flowchart illustrating a method of operating an electronic device according to an embodiment of the disclosure.

In operation 910, the electronic device (e.g., the electronic device 310 of FIG. 5) may detect that the state of any one of multiple links has changed.

In operation 920, the electronic device 310 may identify the maximum data rate of the multiple links.

In operation 930, the electronic device 310 may, based on the maximum data rate, determine whether to change the operating mode of the interface (e.g., the interface 413) of FIG. 5).

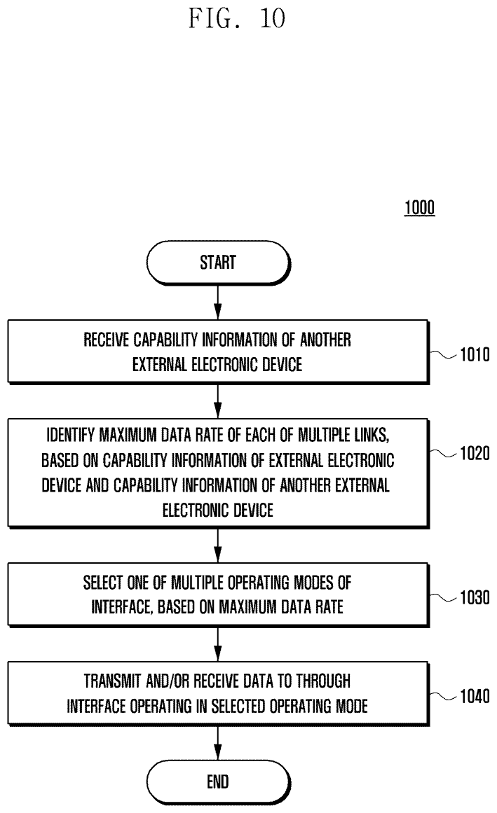

FIG. 10 is an operation flowchart 1000 illustrating a method of operating an electronic device according to an embodiment of the disclosure.

In operation 1010, the electronic device (e.g., the electronic device 310 of FIG. 5) may receive capability information of another external electronic device (e.g., the electronic device 102 of FIG. 1).

In an embodiment, the electronic device 310 may support various wireless communication modes defined in short-range wireless communication. Various wireless communication modes may include a station (STA) mode in which the electronic device 310 receives or transmits data from or to various external electronic devices through the external electronic device 320, a peer-to-peer (P2P) mode (or Wi-Fi direct mode) in which the electronic device 310 is directly connected to an external electronic device (e.g., the external electronic device 102 of FIG. 1) to exchange data, and/or a mobile hot-spot (MHS) mode in which the electronic device 310 performs the role of an access point (AP). As the electronic device 310 simultaneously supports various wireless communication modes, the electronic device 310 may be connected to another external electronic device (e.g., the external electronic device 102 of FIG. 1) through a different mode (e.g., a P2P mode and/or an MHS mode) while being connected to the external electronic device 320 through the STA mode. In the case of simultaneous transmission of various wireless communication modes, the electronic device 310 may control the operating mode of the interface 413, based on a maximum data rate.

The electronic device 310 may detect a connection with another external electronic device (e.g., the external electronic device 102 of FIG. 1) through short-range wireless communication while being connected to the external electronic device 320. Since the electronic device 310 has detected a connection with another external electronic device 102 through short-range wireless communication, the electronic device 310 may request and receive capability information from the other external electronic device 102.

The capability information of the other external electronic device 102 may be, for example, capability information related to short-range wireless communication supported by the other external electronic device 102. For example, the capability information of the other external electronic device 102 may include information regarding the generation of short-range wireless communication (e.g., Wi-Fi 4, Wi-Fi 5, Wi-Fi 6, Wi-Fi6e, and/or Wi-Fi 7) supported by the other external electronic device 102, channel bandwidth information, information indicating the maximum data rate, and/or information indicating the modulation and coding scheme (MCS).

The electronic device 310 may receive capability information of the other external electronic device 102, and establish a link to be connected to the other external electronic device 102, based on the capability information of the other external electronic device 102.

In connection with performing short-range wireless communication with another external electronic device 102, the electronic device 310 may select a link to connect the electronic device 310 with the other external electronic device 102.

According to an example, the electronic device 310 may select one of multiple links, generated between the electronic device 310 and the external electronic device 320, as a link to connect the electronic device 310 with the other external electronic device 102.

After selecting a link, the electronic device 310 may determine characteristics of the selected link, based on capability information of the other external electronic device 102, as part of the operation of link configuration. Determining the characteristics of the selected link may be performed after selecting a link to be activated or during the procedure of selecting a link to be activated. According to an example, the characteristics of the link may include the size of the bandwidth of the link, the MCS level of data to be transmitted or received through the link, and/or the number of spatial streams.

The electronic device 310 may, for example, identify the information related to the selected link and included in the capability information of the other external electronic device 102 (e.g., identification information of APs supporting each of the multiple links, bandwidth information of each of the multiple links, the MCS level of data to be transmitted or received through the multiple links, and the number of spatial streams (N_{SS}) of each of the multiple links), and may determine the characteristics of the link by considering the capability that the electronic device 310 can support.

In operation 1020, the electronic device 310 may identify the maximum data rates of each of the multiple links, based on the capability information of an external electronic device (e.g., the external electronic device 320 of FIG. 4) and the capability information of another external electronic device 320.

According to an example, in the case of selecting one of multiple links, generated between the electronic device 310 and the external electronic device 320, as a link to connect the electronic device 310 with the other external electronic device 102, the electronic device 310 may determine, as the maximum data rate of the selected link, the larger value between the maximum data rate of the data transmitted and/or received through the selected link in the electronic device 310 and the external electronic device 320 and the maximum data rate of the data transmitted and/or received through the selected link in the electronic device 310 and the other external electronic device 102.

According to an example, in case that a first link (e.g., the first link 331 of FIG. 3A) and a second link (e.g., the second link 332 of FIG. 3A) are active between the electronic device 310 and the external electronic device 320, and the second link 332 is active between the electronic device 310 and the other external electronic device 102, the electronic device 310 may, in connection with determining the maximum data rate of the second link 332, determine, as the maximum data rate of the selected link, the larger value between the maximum data rate of the data transmitted and/or received through the selected link in the electronic device 310 and the external electronic device 320 and the maximum data rate of the data transmitted and/or received through the selected link in the electronic device 310 and the other external electronic device 102.

Referring to Table 3, when the electronic device 310 determines the MCS level of the data to be transmitted to or received from the external electronic device 320 through the second link 332 as 10, the maximum data rate of the data transmitted and/or received through the second link 332 between the electronic device 310 and the external electronic device 320 may be 1032.4 Mbps. When the processor 510 determines the MCS level of the data to be transmitted to or received from the other external electronic device 102 through the second link 332 as 11, the maximum data rate of the data transmitted and/or received through the second link 332 between the electronic device 310 and the other external electronic device 102 may be 1147.3 Mbps.

The electronic device 310 may determine, as the maximum data rate of the second link, the larger value (1147.3 Mbps) between the maximum data rate (1032.4 Mbps) of data transmitted and/or received through the second link 332, which is a link selected by the electronic device 310 and the external electronic device 320, and the maximum data rate (1147.3 Mbps) of data transmitted and/or received through the second link 332, which is a link selected by the electronic device 310 and the other external electronic device 102.

The electronic device 310 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1147.1 Mbps of the second link 332). When the electronic device 310 operates in a mode in which data transmission through multiple links is possible, the electronic device 310 may determine, as the maximum data rate of multiple links, the sum of the maximum data rates of each of the multiple links generated between the electronic device 310 and the external electronic device 320. A mode in which the electronic device 310 is capable of transmitting data simultaneously through multiple links is a mode in which simultaneous data transmission through multiple links is possible, and in which the sum of the maximum data rates of each of the multiple links may be the maximum data rate of the multiple links. When the electronic device 310 operates in a mode in which data transmission through multiple links is possible, the electronic device 310 may determine, as the maximum data rate (e.g., 2294.2 Mbps) of multiple links, the sum of the maximum data rates (e.g., 1147.1 Mbps+1147.1 Mbps) of each of the multiple links generated between the electronic device 310 and the external electronic device 320.

In an embodiment, when the electronic device 310 operates in a mode in which data transmission through one of multiple links is possible, the electronic device 310 may determine, as the maximum data rate of the multiple links, the largest data rate among the maximum data rates of each of the multiple links generated between the electronic device 310 and the external electronic device 320. According to an example, the electronic device 310 may, based on the capability information of the external electronic device 320, identify the maximum data rate of multiple links (e.g., the first link 331 and the second link 332) (e.g., the maximum data rate 1147.1 Mbps of the first link 331, and the maximum data rate 1032.4 Mbps of the second link 332). When the electronic device 310 operates in a mode in which data transmission through one of multiple links is possible, the electronic device 310 may determine, as the maximum data rate (e.g., 1147.1 Mbps) of the multiple links, the largest value (e.g., the maximum data rate 1147.1 Mbps of the first link 331) among the maximum data rates of each of the multiple links (e.g., the maximum data rate 1147.1 Mbps of the first link 331 and the maximum data rate 1032.4 Mbps of the second link 332) generated between the electronic device 310 and the external electronic device 320.

According to an example, the electronic device 310 may select a link different from multiple links generated between the electronic device 310 and the external electronic device 320, as a link to connect the electronic device 310 with the other external electronic device 102.

In connection with determining the maximum data rate of the electronic device 310, the electronic device 310 may identify the maximum data rate of each of the multiple links generated between the electronic device 310 and the external electronic device 320 and the maximum data rate of each of at least one link generated between the electronic device 310 and the other external electronic device 102.

The electronic device 310 may determine the maximum data rate of the electronic device 310, based on an operating mode for short-range wireless communication, and select one of multiple operating modes of the interface 413, based on the maximum data rate of the multiple links.

In an embodiment, when the electronic device 310 operates in a mode in which data transmission through multiple links is possible, the electronic device 310 may determine, as the maximum data rate of the multiple links, the sum of the maximum data rates of each of the multiple links generated between the electronic device 310 and the external electronic device 320 and the maximum data rates of each of at least one link generated between the electronic device 310 and the other external electronic device 102. A mode in which the electronic device 310 is capable of transmitting data simultaneously through multiple links is a mode in which simultaneous data transmission through multiple links is possible, and in which the sum of the maximum data rates of each of the multiple links may be the maximum data rate of the multiple links.

When the electronic device 310 operates in a mode in which data transmission through one of multiple links is possible, the electronic device 310 may determine, as the maximum data rate of the electronic device 301, the largest value among the maximum data rates of each of the multiple links generated between the electronic device 310 and the external electronic device 320 and the maximum data rates of each of at least one link generated between the electronic device 310 and the other external electronic device 102.

In operation 1030, the electronic device 310 may, based on the maximum data rate, select one of multiple operating modes of an interface (e.g., the interface 413 of FIG. 5).

The electronic device 310 may determine the maximum data rate of the multiple links, based on the operating mode for short-range wireless communication, and may select one of the multiple operating modes of the interface 413, based on the maximum data rate of the multiple links.

In operation 1040, the electronic device 310 may transmit and/or receive data through an interface operating in a selected operation mode.

The processor 510 may receive data, transmitted by the application processor 411, through the interface 413 operating in the selected operation mode and transmit the data to the external electronic device 320. Alternatively, the processor 510 may transmit data, transmitted by the external electronic device 320, to the application processor 411 through the interface 413 operating in the selected operation mode.

An electronic device according to an embodiment may include a communication module including a processor and a communication circuit supporting short-range wireless communication through multiple links. The electronic device may include an application processor electrically connected to the communication module through an interface supporting multiple operating modes. The processor may, for example, identify the maximum data rate of each of the multiple links, based on capability information of the external electronic device, received from an external electronic device. The processor may identify the maximum data rate of the multiple links, based on an operating mode for the short-range wireless communication. The processor may select one of multiple operating modes of the interface, based on the maximum data rate of the multiple links. The processor may be configured to transmit data to the application processor through the selected operating mode, or receive data, transmitted by the application processor, through the selected interface.

In the electronic device according to embodiment, the processor may be configured to, in case that the operating mode for the short-range wireless communication is an operating mode in which simultaneous data transmission through the multiple links is possible, determine the sum of the data rates of each of the multiple links as the maximum data rate of the multiple links.

In the electronic device according to embodiment, the processor may be configured to, in case that the operating mode for the short-range wireless communication is an operating mode in which while data transmission through one of the multiple links is performed, data transmission through another link is impossible, determine the sum of the data rates of each of the multiple links as the maximum data rate of the multiple links.

In the electronic device according to embodiment, the capability information of the external electronic device may include frequency band information of each of the multiple links, data rate information related to data exchanged through the short-range wireless communication, and/or modulation and coding scheme (MCS) information related to the data.

In the electronic device, the capability information of the external electronic device may be included in a message received during the process of establishing a link between the external electronic device and the electronic device.

In the electronic device according to embodiment, the processor may be configured to select an operating mode of an interface capable of supporting a data rate greater than the maximum data rate of the multiple links.

In the electronic device, the processor may detect that the state of one of the multiple links has changed. The processor may identify whether the maximum data rate of the multiple links has changed, as the state of one of the links has changed. The processor may be configured to, based on the changed maximum data rate, determine whether to change the operating mode of the interface.

In the electronic device according to embodiment, the processor may be configured to detect that the state of the one of the links has changed, based on a TID-to-link mapping message transmitted by the external electronic device or a message related to a power control mode.

In the electronic device according to embodiment, the processor may receive capability information of another external electronic device to be connected through the short-range wireless communication. The processor may be configured to select one of the multiple operating modes, based on the capability information of the external electronic device and the other external electronic device.

In the electronic device, the processor may, based on the capability information of the other external electronic device, identify a maximum data rate of a link between the other external electronic device and the electronic device. The processor may be configured to select one of the multiple operating modes of the interface, based on the maximum data rate of the multiple links and the maximum data rate of the link between the other external electronic device and the electronic device.

A method of operating an electronic device according to an embodiment may include identifying the maximum data rate of each of the multiple links, based on capability information of the external electronic device, received from an external electronic device. The method of operating an electronic device may include determining the maximum data rate of the multiple links, based on an operating mode for the short-range wireless communication. The method of operating an electronic device may include, based on the maximum data rate of the multiple links, selecting one of multiple operating modes supported by an interface between an application processor and a communication module. The method of operating an electronic device may include transmitting data to the application processor through the selected operating mode, or receiving data, transmitted by the application processor, through the selected interface.

In the method of operating an electronic device, the determining of the maximum data rate of the multiple links may include, in case that the operating mode for the short-range wireless communication is an operating mode in which simultaneous data transmission through the multiple links is possible, determining the sum of the data rates of each of the multiple links as the maximum data rate of the multiple links.

In the method of operating an electronic device according to an embodiment, the determining of the maximum data rate of the multiple links may include, in case that the operating mode for the short-range wireless communication is an operating mode in which while data transmission through one of the multiple links is performed, data transmission through another link is impossible, determining the sum of the data rates of each of the multiple links as the maximum data rate of the multiple links.

In the method of operating an electronic device, the capability information of the external electronic device may include frequency band information of each of the multiple links, data rate information related to data exchanged through the short-range wireless communication, and/or modulation and coding scheme (MCS) information related to the data.

In the method of operating an electronic device according to an embodiment, the capability information of the external electronic device may be included in a message received during the process of establishing a link between the external electronic device and the electronic device.

In the method of operating an electronic device according to an embodiment, the selecting of one of multiple operating modes supported by the interface may include selecting an operating mode of an interface capable of supporting a data rate greater than the maximum data rate of the multiple links.

The method of operating an electronic device may further include detecting that the state of one of the multiple links has changed. The method of operating an electronic device may further include identifying whether the maximum data rate of the multiple links has changed as the state of one of the links has changed. The method of operating an electronic device may further include, based on the changed maximum data rate, determining whether to change the operating mode of the interface.

In the method of operating an electronic device according to an embodiment, the detecting of the change of the state of one of the multiple links may include detecting that the state of the one of the links has changed, based on a TID-to-link mapping message transmitted by the external electronic device or a message related to a power control mode.

The method of operating an electronic device according to an embodiment may further include receiving capability information of another external electronic device to be connected through the short-range wireless communication. The method of operating an electronic device according to an embodiment may further include selecting one of the multiple operating modes, based on the capability information of the external electronic device and the other external electronic device.

In the method of operating an electronic device, the selecting of one of the multiple operating modes may include, based on the capability information of the other external electronic device, identifying a maximum data rate of a link between the other external electronic device and the electronic device. The selecting of one of the multiple operating modes may include selecting one of the multiple operating modes of the interface, based on the maximum data rate of the multiple links and the maximum data rate of the link between the other external electronic device and the electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing one or more computer programs;
a communication module including a communication circuit supporting short-range wireless communication through multiple links;
one or more processors communicatively coupled to the memory and the communication module; and
an application processor electrically connected to the communication module through an interface supporting multiple operating modes,
wherein the one or more computer programs include computer-executable instructions that, when executed by the one or more processors individually or collectively, cause the electronic device to:
identify the maximum data rate of each of the multiple links, based on capability information of an external electronic device, received from the external electronic device,
identify the maximum data rate of the multiple links, based on an operating mode for the short-range wireless communication,
select one of the multiple operating modes of the interface, based on the maximum data rate of the multiple links, and
transmit data to the application processor through the selected operating mode, or receive data, transmitted by the application processor, through the selected interface.

2. The electronic device of claim 1, wherein the one or more computer programs further include computer-executable instructions that, when executed by the one or more processors individually or collectively, cause the electronic device to, in case that the operating mode for the short-range wireless communication is an operating mode in which simultaneous data transmission through the multiple links is possible, determine a sum of data rates of the multiple links as the maximum data rate of the multiple links.

3. The electronic device of claim 1, wherein the one or more computer programs further include computer-executable instructions that, when executed by the one or more processors individually or collectively, cause the electronic device to, in case that the operating mode for the short-range wireless communication is an operating mode in which, while data transmission through one of the multiple links is performed, data transmission through another link is impossible, determine a largest data rate among the maximum data rates of each of the multiple links as the maximum data rate of the multiple links.

4. The electronic device of claim 1, wherein the capability information of the external electronic device comprises frequency band information of each of the multiple links, data rate information related to data exchanged through the short-range wireless communication, and/or modulation and coding scheme (MCS) information related to the data.

5. The electronic device of claim 1, wherein the capability information of the external electronic device is included in a message received during a process of establishing a link between the external electronic device and the electronic device.

6. The electronic device of claim 1, wherein the one or more computer programs further include computer-executable instructions that, when executed by the one or more processors individually or collectively, cause the electronic device to select an operating mode of the interface, which can support a greater data rate than the maximum data rate of the multiple links.

7. The electronic device of claim 1, wherein the one or more computer programs further include computer-executable instructions that, when executed by the one or more processors individually or collectively, cause the electronic device to:
detect a change in a state of one of the multiple links;
identify whether the maximum data rate of the multiple links is changed according to the change in the state of one of the links; and
based on the changed maximum data rate, determine whether to change the operating mode of the interface.

8. The electronic device of claim 7, wherein the one or more computer programs further include computer-executable instructions that, when executed by the one or more processors individually or collectively, cause the electronic device to detect a change in the state of one of the links is changed, based on a traffic identifier (TID)-to-link mapping message transmitted by the external electronic device or a message related to a power control mode.

9. The electronic device of claim 1, wherein the one or more computer programs further include computer-executable instructions that, when executed by the one or more processors individually or collectively, cause the electronic device to:
receive capability information of any other external electronic device to be connected through the short-range wireless communication; and
select one of the multiple operating modes, based on the capability information of the external electronic device and the other external electronic device.

10. The electronic device of claim 9, wherein the one or more computer programs further include computer-executable instructions that, when executed by the one or more processors individually or collectively, cause the electronic device to:
based on the capability information of the other external electronic device, identify the maximum data rate of a link between the other external electronic device and the electronic device; and
select one of the multiple operating modes of the interface, based on the maximum data rate of the multiple links and the maximum data rate of the link between the other external electronic device and the electronic device.

11. A method of operating an electronic device, the method comprising:
identifying the maximum data rate of each of multiple links for short-range wireless communication, based on capability information of an external electronic device, received from the external electronic device;
determining the maximum data rate of the multiple links, based on an operating mode for the short-range wireless communication;
based on the maximum data rate of the multiple links, selecting one of multiple operating modes supported by an interface between an application processor and a communication module; and
transmitting data to the application processor through the selected operating mode, or receiving data, transmitted by the application processor, through the selected interface.

12. The method of claim 11, wherein the determining of the maximum data rate of the multiple links comprises, in case that the operating mode for the short-range wireless communication is an operating mode in which simultaneous data transmission through the multiple links is possible, determining a sum of data rates of the multiple links as the maximum data rate of the multiple links.

13. The method of claim 11, wherein the determining of the maximum data rate of the multiple links comprises, in case that the operating mode for the short-range wireless communication is an operating mode in which, while data transmission through one of the multiple links is performed, data transmission through another link is impossible, determining a largest data rate among the maximum data rates of each of the multiple links as the maximum data rate of the multiple links.

14. The method of claim 11, wherein the capability information of the external electronic device comprises frequency band information of each of the multiple links, data rate information related to data exchanged through the short-range wireless communication, and/or modulation and coding scheme (MCS) information related to the data.

15. The method of claim 11, wherein the capability information of the external electronic device is included in a message received during a process of establishing a link between the external electronic device and the electronic device.

16. The method of claim 11, further comprising:
selecting an operating mode of the interface, which can support a greater data rate than the maximum data rate of the multiple links.

17. The method of claim 11, further comprising:
detecting a change in a state of one of the multiple links;
identifying whether the maximum data rate of the multiple links is changed according to the change in the state of one of the links;
based on the changed maximum data rate, determining whether to change the operating mode of the interface; and
detecting a change in the state of one of the links is changed, based on a traffic identifier (TID)-to-link mapping message transmitted by the external electronic device or a message related to a power control mode.

18. The method of claim 11, further comprising:
receiving capability information of any other external electronic device to be connected through the short-range wireless communication;
selecting one of the multiple operating modes, based on the capability information of the external electronic device and the other external electronic device;
based on the capability information of the other external electronic device, identifying the maximum data rate of a link between the other external electronic device and the electronic device; and
selecting one of the multiple operating modes of the interface, based on the maximum data rate of the multiple links and the maximum data rate of the link between the other external electronic device and the electronic device.

19. One or more non-transitory computer-readable storage media storing one or more computer programs including computer-executable instructions that, when executed by one or more processors of an electronic device individually or collectively, cause the electronic device to perform operations, the operations comprising:
identifying the maximum data rate of each of multiple links for short-range wireless communication, based on capability information of an external electronic device, received from the external electronic device;
determining the maximum data rate of the multiple links, based on an operating mode for the short-range wireless communication;
based on the maximum data rate of the multiple links, selecting one of multiple operating modes supported by an interface between an application processor and a communication module; and
transmitting data to the application processor through the selected operating mode, or receiving data, transmitted by the application processor, through the selected interface.

20. The one or more non-transitory computer-readable storage media of claim 19, wherein the determining of the maximum data rate of the multiple links comprises, in case that the operating mode for the short-range wireless communication is an operating mode in which simultaneous data transmission through the multiple links is possible, determining a sum of data rates of the multiple links as the maximum data rate of the multiple links.
